(19) United States
(12) Patent Application Publication
(10) Pub. No.: US 2025/0378124 A1
(43) Pub. Date: Dec. 11, 2025

(54) System, Method, and Computer Program Product for Generating a Customized User Interface Based on User Interactions

(71) Applicant: Visa International Service Association, San Francisco, CA (US)

(72) Inventors: Neeraj Surana, Bengaluru (IN); Alok Roy, Bengaluru (IN); Ravi Shanker Kumar Sinha, Bengaluru (IN); Shivam Mohan, Lucknow (IN)

(21) Appl. No.: 18/736,999

(22) Filed: Jun. 7, 2024

(51) Int. Cl. G06F 16/957; G06F 16/9535; G06F 40/205; G06F 40/284

(52) U.S. Cl. CPC G06F 16/9577; G06F 16/9535; G06F 40/205; G06F 40/284

(57) ABSTRACT

Systems, methods, and computer program products are provided for generating a customized user interface based on user interactions. The system includes a processor configured to receive a user request from a user device to access a resource. In response to the user request, the system retrieves program code configured to cause display of the resource. The system generates a first version of the resource based on the program code and collects interaction data based on sensed interactions of a user of the user device with the displayed first version of the resource. The system inputs the interaction data into a first machine learning model to generate associations between user interaction types from the interaction data and display update actions. The system generates, by a second machine learning model, a second version of the resource based on the at least one display update action for the first version of the resource.

### BACKGROUND

### 1. Technical Field

This disclosure relates generally to user customized interfaces and, in non-limiting embodiments or aspects, to systems, methods, and computer program products for generating a customized user interface based on user interactions.

### 2. Technical Considerations

There are many scenarios where building customized interfaces for users can immensely help to not only improve product reach, but also enhance the experience of each and every individual using that product. For example, there are many guidelines and laws around the world, such as the Americans with Disabilities Act (ADA) that mandate the development of applications that ensure ease of access for specially-abled individuals.

Additionally, when products are built in the native languages of the users, they are more likely to enhance individual user experience and attract more customers for the product. However, the development of applications that cater to the needs of every individual or a group of individuals based on their requirements is a difficult task and requires an extensive amount of effort to accomplish.

Thus, it is desirable to build an application that is inclusive and can be easily adopted around the world, which may comply with e.g., the regulatory guidelines created to ensure ease of accessibility for every individual. Additionally, it is desirable for the application to be easy to use for all users.

### SUMMARY

Accordingly, provided are improved systems, methods, and computer program products for generating a customized user interface based on user interactions.

Generative artificial intelligence-based methods and systems that allow or provide individual customizations to user interfaces and/or content in real-time or near real-time are disclosed. In some non-limiting embodiments or aspects, methods and systems have the ability to sense user feedback based on user interaction and further improve the user experience by re-rendering interactive user interfaces customized to user specific needs, until the user seems satisfied or is able to accomplish what they have set out to do.

According to non-limiting embodiments or aspects, provided is a system including at least one processor configured to: receive a user request from a user device to access a resource; in response to receiving the user request, retrieve program code configured to cause display of the resource; generate a first version of the resource based on the program code, the first version of the resource displayed on the user device; collect interaction data based on sensed interactions of a user of the user device with the displayed first version of the resource; input the interaction data into a first machine learning model configured to generate associations between user interaction types from the interaction data and display update actions, the first machine learning model configured to generate at least one display update action for the first version of the resource; and generate, by a second machine learning model, a second version of the resource based on the at least one display update action for the first version of the resource, the second version of the resource displayed on the user device.

In non-limiting embodiments or aspects, the at least one processor is further configured to: input the at least one display update action for the first version of the resource and the program code into the second machine learning model configured to modify the program code based on the at least one display update action for the first version of the resource; receive modified program code to effect the at least one display update action for the first version of the resource, where the second version of the resource is generated based on the modified program code.

In non-limiting embodiments or aspects, where when receiving the user request to access a resource, the at least one processor is configured to: receive a URL request in a browser to render a webpage; and receive at least one parameter related to how the webpage is rendered.

In non-limiting embodiments or aspects, where when retrieving program code configured to cause display of the resource, the at least one processor is configured to: connect to a server hosting the resource; request the program code configured to cause display of the resource, including at least one parameter related to how the resource is rendered; and receive a response including the program code from the server hosting the resource, where the first version of the resource is generated based on the response.

In non-limiting embodiments or aspects, where when collecting interaction data, the at least one processor is configured to: monitor the sensed interactions of the user of the user device for a feedback event, the feedback event is explicit or implicit.

In non-limiting embodiments or aspects, the monitoring for a feedback event includes continuously and/or continually monitoring for any feedback events based on the sensed interactions of the user of the user device in real-time.

In non-limiting embodiments or aspects, the feedback event is based on a user interaction pattern.

In non-limiting embodiments or aspects, the feedback event is an explicit request from the user.

In non-limiting embodiments or aspects, the feedback event is an implicit request from the user.

In non-limiting embodiments or aspects, where when inputting the interaction data into the first machine learning model, the at least one processor is configured to: parse the collected interaction data into first text data; tokenize the first text data to produce a first plurality of tokens; and encode the first plurality of tokens into a first plurality of vectors, the first plurality of vectors being input to the first machine learning model.

In non-limiting embodiments or aspects, the at least one processor configured to: input content from the first version of the resource into the first machine learning model by: parsing the content of the first version of the resource into second text data; tokenizing the second text data to produce a second plurality of tokens; and encoding the second plurality of tokens into a second plurality of vectors, the second plurality of vectors being input to the first machine learning model.

In non-limiting embodiments or aspects, the first machine learning model is configured to combine the first plurality of vectors and the second plurality of vectors to produce a third plurality of vectors, the third plurality of vectors corresponding to input used to generate the second version of the resource.

In non-limiting embodiments or aspects, the at least one processor configured to: input the third plurality of vectors into the second machine learning model, the second machine learning model configured to: decode the third plurality of vectors into a third plurality of tokens; detokenize the third plurality of tokens into third text data; and convert the third text data into modified program code for generating the second version of the resource.

In non-limiting embodiments or aspects, the resource includes at least one of a webpage, a mobile app, and/or a gaming environment.

In non-limiting embodiments or aspects, where generating the first version and/or the second version of the resource includes generating and rendering the first version and/or the second version of the resource.

In non-limiting embodiments or aspects, the at least one processor is further configured to: input the interaction data into a first machine learning model configured to generate associations between user interaction types from the interaction data and display update actions, the first machine learning model configured to generate at least one display update action for the second version of the resource; and generate, by a second machine learning model, a third version of the resource based on the at least one display update action for the second version of the resource, the third version of the resource displayed on the user device.

In non-limiting embodiments or aspects, the at least one processor further configured to: input the at least one display update action for the second version of the resource and the program code into the second machine learning model configured to modify the program code based on the at least one display update action for the second version of the resource; receive modified program code to effect the at least one display update action for the second version of the resource, where the third version of the resource is generated based on the modified program code.

In non-limiting embodiments or aspects, where when inputting the interaction data into the first machine learning model, the at least one processor is configured to: parse the collected interaction data into fourth text data; tokenize the fourth text data to produce a fourth plurality of tokens; and encode the fourth plurality of tokens into a fourth plurality of vectors, the fourth plurality of vectors being input to the first machine learning model.

In non-limiting embodiments or aspects, the at least one processor configured to: input the content from the second version of the resource into the first machine learning model by: parsing the content of the second version of the resource back into third text data; tokenizing the third text data to produce the third plurality of tokens; and encoding the third plurality of tokens into the third plurality of vectors, the third plurality of vectors being input to the first machine learning model.

In non-limiting embodiments or aspects, the first machine learning model is configured to combine the fourth plurality of vectors and the third plurality of vectors to produce a fifth plurality of vectors, the fifth plurality of vectors corresponding to input used to generate the third version of the resource.

According to non-limiting embodiments or aspects, provided is a computer-implemented method, including: receiving, with at least one processor, a user request from a user device to access a resource; retrieving, with at least one processor, program code configured to cause display of the resource; generating, with at least one processor, a first version of the resource based on the program code, the first version of the resource displayed on the user device; collecting, with at least one processor, interaction data based on sensed interactions of a user of the user device with the displayed first version of the resource; inputting, with at least one processor, the interaction data into a first machine learning model configured to generate associations between user interaction types from the interaction data and display update actions, the first machine learning model configured to generate at least one display update action for the first version of the resource; and generating, with at least one processor, by a second machine learning model, a second version of the resource based on the at least one display update action for the first version of the resource, the second version of the resource displayed on the user device.

In non-limiting embodiments or aspects, the method further including: inputting the at least one display update action for the first version of the resource and the program code into the second machine learning model configured to modify the program code based on the at least one display update action for the first version of the resource; and receiving modified program code to effect the at least one display update action for the first version of the resource, the second version of the resource is generated based on the modified program code.

In non-limiting embodiments or aspects, where when receiving the user request to access a resource, the method includes: receiving a URL request in a browser to render a webpage; and receiving at least one parameter related to how the webpage is rendered.

In non-limiting embodiments or aspects, where when retrieving program code configured to cause display of the resource, the method includes: connecting to a server hosting the resource; requesting the program code configured to cause display of the resource, including at least one parameter related to how the resource is rendered; and receiving a response including the program code from the server hosting the resource, the first version of the resource is generated based on the response.

In non-limiting embodiments or aspects, where when collecting interaction data, the method includes: monitoring the sensed interactions of the user of the user device for a feedback event, where the feedback event is explicit or implicit.

In non-limiting embodiments or aspects, the monitoring for a feedback event includes continuously and/or continually monitoring for any feedback events based on the sensed interactions of the user of the user device in real-time.

In non-limiting embodiments or aspects, the feedback event is based on a user interaction pattern.

In non-limiting embodiments or aspects, the feedback event is an explicit request from the user.

In non-limiting embodiments or aspects, the feedback event is an implicit request from the user.

In non-limiting embodiments or aspects, where when inputting the interaction data into the first machine learning model, the method includes: parsing the collected interaction data into first text data; tokenizing the first text data to produce a first plurality of tokens; and encoding the first plurality of tokens into a first plurality of vectors, the first plurality of vectors being input to the first machine learning model.

In non-limiting embodiments or aspects, the method including: inputting content from the first version of the resource into the first machine learning model by: parsing the content of the first version of the resource into second text data; tokenizing the second text data to produce a second plurality of tokens; and encoding the second plurality of tokens into a second plurality of vectors, the second plurality of vectors being input to the first machine learning model.

In non-limiting embodiments or aspects, the first machine learning model is configured to combine the first plurality of vectors and the second plurality of vectors to produce a third plurality of vectors, the third plurality of vectors corresponding to input used to generate the second version of the resource.

In non-limiting embodiments or aspects, the method including: inputting the third plurality of vectors into the second machine learning model, the second machine learning model configured to: decoding the third plurality of vectors into a third plurality of tokens; detokenizing the third plurality of tokens into third text data; and converting the third text data into modified program code for generating the second version of the resource.

In non-limiting embodiments or aspects, the resource includes at least one of a webpage, a mobile app, and/or a gaming environment.

In non-limiting embodiments or aspects, where generating the first version and/or the second version of the resource includes generating and rendering the first version and/or the second version of the resource.

In non-limiting embodiments or aspects, the method further including: inputting the interaction data into a first machine learning model configured to generate associations between user interaction types from the interaction data and display update actions, the first machine learning model configured to generate at least one display update action for the second version of the resource; and generating, by a second machine learning model, a third version of the resource based on the at least one display update action for the second version of the resource, the third version of the resource displayed on the user device.

In non-limiting embodiments or aspects, the method further including: inputting the at least one display update action for the second version of the resource and the program code into the second machine learning model configured to modify the program code based on the at least one display update action for the second version of the resource; and receiving modified program code to effect the at least one display update action for the second version of the resource, where the third version of the resource is generated based on the modified program code.

In non-limiting embodiments or aspects, where when inputting the interaction data into the first machine learning model, the method including: parsing the collected interaction data into fourth text data; tokenizing the fourth text data to produce a fourth plurality of tokens; and encoding the fourth plurality of tokens into a fourth plurality of vectors, the fourth plurality of vectors being input to the first machine learning model.

In non-limiting embodiments or aspects, the method including: inputting the content from the second version of the resource into the first machine learning model by: parsing the content of the second version of the resource back into third text data; tokenizing the third text data to produce the third plurality of tokens; and encoding the third plurality of tokens into the third plurality of vectors, the third plurality of vectors being input to the first machine learning model.

In non-limiting embodiments or aspects, the first machine learning model is configured to combine the fourth plurality of vectors and the third plurality of vectors to produce a fifth plurality of vectors, the fifth plurality of vectors corresponding to input used to generate the third version of the resource.

According to non-limiting embodiments or aspects, provided is a computer program product including at least one non-transitory computer-readable medium including program instructions that, when executed by at least one processor, cause the at least one processor to: receive a user request from a user device to access a resource; retrieve program code configured to cause display of the resource; generate a first version of the resource based on the program code, the first version of the resource displayed on the user device; collect interaction data based on sensed interactions of a user of the user device with the displayed first version of the resource; input the interaction data into a first machine learning model configured to generate associations between user interaction types from the interaction data and display update actions, the first machine learning model configured to generate at least one display update action for the first version of the resource; and generate, by a second machine learning model, a second version of the resource based on the at least one display update action for the first version of the resource, the second version of the resource displayed on the user device.

In non-limiting embodiments or aspects, the at least one processor is further configured to: input the at least one display update action for the first version of the resource and the program code into the second machine learning model configured to modify the program code based on the at least one display update action for the first version of the resource; and receive modified program code to effect the at least one display update action for the first version of the resource, the second version of the resource is generated based on the modified program code.

In non-limiting embodiments or aspects, where when receiving the user request to access a resource, the at least one processor is configured to: receive a URL request in a browser to render a webpage; and receive at least one parameter related to how the webpage is rendered.

In non-limiting embodiments or aspects, where when retrieving program code configured to cause display of the resource, the at least one processor is configured to: connect to a server hosting the resource; request the program code configured to cause display of the resource, including at least one parameter related to how the resource is rendered; and receive a response including the program code from the server hosting the resource, where the first version of the resource is generated based on the response.

In non-limiting embodiments or aspects, where when collecting interaction data, the at least one processor is configured to: monitor the sensed interactions of the user of the user device for a feedback event, where the feedback event is explicit or implicit.

In non-limiting embodiments or aspects, the monitoring for a feedback event includes continuously and/or continually monitoring for any feedback events based on the sensed interactions of the user of the user device in real-time.

In non-limiting embodiments or aspects, the feedback event is based on a user interaction pattern.

In non-limiting embodiments or aspects, the feedback event is an explicit request from the user.

In non-limiting embodiments or aspects, the feedback event is an implicit request from the user.

In non-limiting embodiments or aspects, where when inputting the interaction data into the first machine learning model, the at least one processor is configured to: parse the collected interaction data into first text data; tokenize the first text data to produce a first plurality of tokens; and encode the first plurality of tokens into a first plurality of vectors, the first plurality of vectors being input to the first machine learning model.

In non-limiting embodiments or aspects, the at least one processor configured to: input content from the first version of the resource into the first machine learning model by: parsing the content of the first version of the resource into second text data; tokenizing the second text data to produce a second plurality of tokens; and encoding the second plurality of tokens into a second plurality of vectors, the second plurality of vectors being input to the first machine learning model.

In non-limiting embodiments or aspects, the first machine learning model is configured to combine the first plurality of vectors and the second plurality of vectors to produce a third plurality of vectors, the third plurality of vectors corresponding to input used to generate the second version of the resource.

In non-limiting embodiments or aspects, the at least one processor configured to: input the third plurality of vectors into the second machine learning model, the second machine learning model configured to: decode the third plurality of vectors into a third plurality of tokens; detokenize the third plurality of tokens into third text data; and convert the third text data into modified program code for generating the second version of the resource.

In non-limiting embodiments or aspects, the resource includes at least one of a webpage, a mobile app, and/or a gaming environment.

In non-limiting embodiments or aspects, where generating the first version and/or the second version of the resource includes generating and rendering the first version and/or the second version of the resource.

In non-limiting embodiments or aspects, the at least one processor is further configured to: input the interaction data into a first machine learning model configured to generate associations between user interaction types from the interaction data and display update actions, the first machine learning model configured to generate at least one display update action for the second version of the resource; and generate, by a second machine learning model, a third version of the resource based on the at least one display update action for the second version of the resource, the third version of the resource displayed on the user device.

In non-limiting embodiments or aspects, the at least one processor further configured to: input the at least one display update action for the second version of the resource and the program code into the second machine learning model configured to modify the program code based on the at least one display update action for the second version of the resource; receive modified program code to effect the at least one display update action for the second version of the resource, where the third version of the resource is generated based on the modified program code.

In non-limiting embodiments or aspects, where when inputting the interaction data into the first machine learning model, the at least one processor is configured to: parse the collected interaction data into fourth text data; tokenize the fourth text data to produce a fourth plurality of tokens; and encode the fourth plurality of tokens into a fourth plurality of vectors, the fourth plurality of vectors being input to the first machine learning model.

In non-limiting embodiments or aspects, the at least one processor configured to: input the content from the second version of the resource into the first machine learning model by: parsing the content of the second version of the resource back into third text data; tokenizing the third text data to produce the third plurality of tokens; and encoding the third plurality of tokens into the third plurality of vectors, the third plurality of vectors being input to the first machine learning model.

In non-limiting embodiments or aspects, the first machine learning model is configured to combine the fourth plurality of vectors and the third plurality of vectors to produce a fifth plurality of vectors, the fifth plurality of vectors corresponding to input used to generate the third version of the resource.

Further non-limiting embodiments or aspects are set forth in the following numbered clauses:

Clause 1: A system comprising at least one processor configured to: receive a user request from a user device to access a resource; in response to receiving the user request, retrieve program code configured to cause display of the resource; generate a first version of the resource based on the program code, the first version of the resource displayed on the user device; collect interaction data based on sensed interactions of a user of the user device with the displayed first version of the resource; input the interaction data into a first machine learning model configured to generate associations between user interaction types from the interaction data and display update actions, the first machine learning model configured to generate at least one display update action for the first version of the resource; and generate, by a second machine learning model, a second version of the resource based on the at least one display update action for the first version of the resource, the second version of the resource displayed on the user device.

Clause 2: The system of clause 1, wherein the at least one processor is further configured to: input the at least one display update action for the first version of the resource and the program code into the second machine learning model configured to modify the program code based on the at least one display update action for the first version of the resource; and receive modified program code to effect the at least one display update action for the first version of the resource, wherein the second version of the resource is generated based on the modified program code.

Clause 3: The system of clause 1 or 2, wherein when receiving the user request to access a resource, the at least one processor is configured to: receive a URL request in a browser to render a webpage; and receive at least one parameter related to how the webpage is rendered.

Clause 4: The system of any of clauses 1-3, wherein when retrieving program code configured to cause display of the resource, the at least one processor is configured to: connect to a server hosting the resource; request the program code configured to cause display of the resource, including at least one parameter related to how the resource is rendered; and receive a response comprising the program code from the server hosting the resource, wherein the first version of the resource is generated based on the response.

Clause 5: The system of any of clauses 1-4, wherein when collecting interaction data, the at least one processor is configured to: monitor the sensed interactions of the user of the user device for a feedback event, wherein the feedback event is explicit or implicit.

Clause 6: The system of any of clauses 1-5, wherein the monitoring for a feedback event comprises continuously and/or continually monitoring for any feedback events based on the sensed interactions of the user of the user device in real-time.

Clause 7: The system of any of clauses 1-6, wherein the feedback event is based on a user interaction pattern.

Clause 8: The system of any of clauses 1-7, wherein the feedback event is an explicit request from the user.

Clause 9: The system of any of clauses 1-8, wherein the feedback event is an implicit request from the user.

Clause 10: The system of any of clauses 1-9, wherein when inputting the interaction data into the first machine learning model, the at least one processor is configured to: parse the collected interaction data into first text data; tokenize the first text data to produce a first plurality of tokens; and encode the first plurality of tokens into a first plurality of vectors, the first plurality of vectors being input to the first machine learning model.

Clause 11: The system of any of clauses 1-10, the at least one processor configured to: input content from the first version of the resource into the first machine learning model by: parsing the content of the first version of the resource into second text data; tokenizing the second text data to produce a second plurality of tokens; and encoding the second plurality of tokens into a second plurality of vectors, the second plurality of vectors being input to the first machine learning model.

Clause 12: The system of any of clauses 1-11, wherein the first machine learning model is configured to combine the first plurality of vectors and the second plurality of vectors to produce a third plurality of vectors, the third plurality of vectors corresponding to input used to generate the second version of the resource.

Clause 13: The system of any of clauses 1-12, the at least one processor configured to: input the third plurality of vectors into the second machine learning model, the second machine learning model configured to: decode the third plurality of vectors into a third plurality of tokens; detokenize the third plurality of tokens into third text data; and convert the third text data into modified program code for generating the second version of the resource.

Clause 14: The system of any of clauses 1-13, wherein the resource comprises at least one of a webpage, a mobile app, and/or a gaming environment.

Clause 15: The system of any of clauses 1-14, wherein generating the first version and/or the second version of the resource comprises generating and rendering the first version and/or the second version of the resource.

Clause 16: The system of any of clauses 1-15, wherein the at least one processor is further configured to: input the interaction data into a first machine learning model configured to generate associations between user interaction types from the interaction data and display update actions, the first machine learning model configured to generate at least one display update action for the second version of the resource; generate, by a second machine learning model, a third version of the resource based on the at least one display update action for the second version of the resource, the third version of the resource displayed on the user device.

Clause 17: The system of any of clauses 1-16, the at least one processor further configured to: input the at least one display update action for the second version of the resource and the program code into the second machine learning model configured to modify the program code based on the at least one display update action for the second version of the resource; receive modified program code to effect the at least one display update action for the second version of the resource, wherein the third version of the resource is generated based on the modified program code.

Clause 18: The system of any of clauses 1-17, wherein when inputting the interaction data into the first machine learning model, the at least one processor is configured to: parse the collected interaction data into fourth text data; tokenize the fourth text data to produce a fourth plurality of tokens; and encode the fourth plurality of tokens into a fourth plurality of vectors, the fourth plurality of vectors being input to the first machine learning model.

Clause 19: The system of any of clauses 1-18, the at least one processor configured to: input the content from the second version of the resource into the first machine learning model by: parsing the content of the second version of the resource back into third text data; tokenizing the third text data to produce the third plurality of tokens; and encoding the third plurality of tokens into the third plurality of vectors, the third plurality of vectors being input to the first machine learning model.

Clause 20: The system of any of clauses 1-19, wherein the first machine learning model is configured to combine the fourth plurality of vectors and the third plurality of vectors to produce a fifth plurality of vectors, the fifth plurality of vectors corresponding to input used to generate the third version of the resource.

Clause 21: A computer-implemented method, comprising: receiving, with at least one processor, a user request from a user device to access a resource; retrieving, with at least one processor, program code configured to cause display of the resource; generating, with at least one processor, a first version of the resource based on the program code, the first version of the resource displayed on the user device; collecting, with at least one processor, interaction data based on sensed interactions of a user of the user device with the displayed first version of the resource; inputting, with at least one processor, the interaction data into a first machine learning model configured to generate associations between user interaction types from the interaction data and display update actions, the first machine learning model configured to generate at least one display update action for the first version of the resource; and generating, with at least one processor, by a second machine learning model, a second version of the resource based on the at least one display update action for the first version of the resource, the second version of the resource displayed on the user device.

Clause 22: The method of clause 21, further comprising: inputting the at least one display update action for the first version of the resource and the program code into the second machine learning model configured to modify the program code based on the at least one display update action for the first version of the resource; and receiving modified program code to effect the at least one display update action for the first version of the resource, wherein the second version of the resource is generated based on the modified program code.

Clause 23: The method of clause 21 or 22, wherein when receiving the user request to access a resource, the method comprises: receiving a URL request in a browser to render a webpage; and receiving at least one parameter related to how the webpage is rendered.

Clause 24: The method of any of clauses 21-23, wherein when retrieving program code configured to cause display of the resource, the method comprises: connecting to a server hosting the resource; requesting the program code configured to cause display of the resource, including at least one parameter related to how the resource is rendered; and receiving a response comprising the program code from the server hosting the resource, wherein the first version of the resource is generated based on the response.

Clause 25: The method of any of clauses 21-24, wherein when collecting interaction data, the method comprises: monitoring the sensed interactions of the user of the user device for a feedback event, wherein the feedback event is explicit or implicit.

Clause 26: The method of any of clauses 21-25, wherein the monitoring for a feedback event comprises continuously and/or continually monitoring for any feedback events based on the sensed interactions of the user of the user device in real-time.

Clause 27: The method of any of clauses 21-26, wherein the feedback event is based on a user interaction pattern.

Clause 28: The method of any of clauses 21-27, wherein the feedback event is an explicit request from the user.

Clause 29: The method of any of clauses 21-28, wherein the feedback event is an implicit request from the user.

Clause 30: The method of any of clauses 21-29, wherein when inputting the interaction data into the first machine learning model, the method comprises: parsing the collected interaction data into first text data; tokenizing the first text data to produce a first plurality of tokens; and encoding the first plurality of tokens into a first plurality of vectors, the first plurality of vectors being input to the first machine learning model.

Clause 31: The method of any of clauses 21-30, comprising: inputting content from the first version of the resource into the first machine learning model by: parsing the content of the first version of the resource into second text data; tokenizing the second text data to produce a second plurality of tokens; and encoding the second plurality of tokens into a second plurality of vectors, the second plurality of vectors being input to the first machine learning model.

Clause 32: The method of any of clauses 21-31, wherein the first machine learning model is configured to combine the first plurality of vectors and the second plurality of vectors to produce a third plurality of vectors, the third plurality of vectors corresponding to input used to generate the second version of the resource.

Clause 33: The method of any of clauses 21-32, comprising: inputting the third plurality of vectors into the second machine learning model, the second machine learning model configured to: decoding the third plurality of vectors into a third plurality of tokens; detokenizing the third plurality of tokens into third text data; and converting the third text data into modified program code for generating the second version of the resource.

Clause 34: The method of any of clauses 21-33, wherein the resource comprises at least one of a webpage, a mobile app, and/or a gaming environment.

Clause 35: The method of any of clauses 21-34, wherein generating the first version and/or the second version of the resource comprises generating and rendering the first version and/or the second version of the resource.

Clause 36: The method of any of clauses 21-35, further comprising: inputting the interaction data into a first machine learning model configured to generate associations between user interaction types from the interaction data and display update actions, the first machine learning model configured to generate at least one display update action for the second version of the resource; and generating, by a second machine learning model, a third version of the resource based on the at least one display update action for the second version of the resource, the third version of the resource displayed on the user device.

Clause 37: The method of any of clauses 21-36, further comprising: inputting the at least one display update action for the second version of the resource and the program code into the second machine learning model configured to modify the program code based on the at least one display update action for the second version of the resource; and receiving modified program code to effect the at least one display update action for the second version of the resource, wherein the third version of the resource is generated based on the modified program code.

Clause 38: The method of any of clauses 21-37, wherein when inputting the interaction data into the first machine learning model, the method comprising: parsing the collected interaction data into fourth text data; tokenizing the fourth text data to produce a fourth plurality of tokens; and encoding the fourth plurality of tokens into a fourth plurality of vectors, the fourth plurality of vectors being input to the first machine learning model.

Clause 39: The method of any of clauses 21-38, comprising: inputting the content from the second version of the resource into the first machine learning model by: parsing the content of the second version of the resource back into third text data; tokenizing the third text data to produce the third plurality of tokens; and encoding the third plurality of tokens into the third plurality of vectors, the third plurality of vectors being input to the first machine learning model.

Clause 40: The method of any of clauses 21-39, wherein the first machine learning model is configured to combine the fourth plurality of vectors and the third plurality of vectors to produce a fifth plurality of vectors, the fifth plurality of vectors corresponding to input used to generate the third version of the resource.

Clause 41: A computer program product comprising at least one non-transitory computer-readable medium including program instructions that, when executed by at least one processor, cause the at least one processor to: receive a user request from a user device to access a resource; retrieve program code configured to cause display of the resource; generate a first version of the resource based on the program code, the first version of the resource displayed on the user device; collect interaction data based on sensed interactions of a user of the user device with the displayed first version of the resource; input the interaction data into a first machine learning model configured to generate associations between user interaction types from the interaction data and display update actions, the first machine learning model configured to generate at least one display update action for the first version of the resource; and generate, by a second machine learning model, a second version of the resource based on the at least one display update action for the first version of the resource, the second version of the resource displayed on the user device.

Clause 42: The computer program product of clause 41, wherein the at least one processor is further configured to: input the at least one display update action for the first version of the resource and the program code into the second machine learning model configured to modify the program code based on the at least one display update action for the first version of the resource; and receive modified program code to effect the at least one display update action for the first version of the resource, wherein the second version of the resource is generated based on the modified program code.

Clause 43: The computer program product of clause 41 or 42, wherein when receiving the user request to access a resource, the at least one processor is configured to: receive a URL request in a browser to render a webpage; and receive at least one parameter related to how the webpage is rendered.

Clause 44: The computer program product of any of clauses 41-43, wherein when retrieving program code configured to cause display of the resource, the at least one processor is configured to: connect to a server hosting the resource; request the program code configured to cause display of the resource, including at least one parameter related to how the resource is rendered; and receive a response comprising the program code from the server hosting the resource, wherein the first version of the resource is generated based on the response.

Clause 45: The computer program product of any of clauses 41-44, wherein when collecting interaction data, the at least one processor is configured to: monitor the sensed interactions of the user of the user device for a feedback event, wherein the feedback event is explicit or implicit.

Clause 46: The computer program product of any of clauses 41-45, wherein the monitoring for a feedback event comprises continuously and/or continually monitoring for any feedback events based on the sensed interactions of the user of the user device in real-time.

Clause 47: The computer program product of any of clauses 41-46, wherein the feedback event is based on a user interaction pattern.

Clause 48: The computer program product of any of clauses 41-47, wherein the feedback event is an explicit request from the user.

Clause 49: The computer program product of any of clauses 41-48, wherein the feedback event is an implicit request from the user.

Clause 50: The computer program product of any of clauses 41-49, wherein when inputting the interaction data into the first machine learning model, the at least one processor is configured to: parse the collected interaction data into first text data; tokenize the first text data to produce a first plurality of tokens; and encode the first plurality of tokens into a first plurality of vectors, the first plurality of vectors being input to the first machine learning model.

Clause 51: The computer program product of any of clauses 41-50, the at least one processor configured to: input content from the first version of the resource into the first machine learning model by: parsing the content of the first version of the resource into second text data; tokenizing the second text data to produce a second plurality of tokens; and encoding the second plurality of tokens into a second plurality of vectors, the second plurality of vectors being input to the first machine learning model.

Clause 52: The computer program product of any of clauses 41-51, wherein the first machine learning model is configured to combine the first plurality of vectors and the second plurality of vectors to produce a third plurality of vectors, the third plurality of vectors corresponding to input used to generate the second version of the resource.

Clause 53: The computer program product of any of clauses 41-52, the at least one processor configured to: input the third plurality of vectors into the second machine learning model, the second machine learning model configured to: decode the third plurality of vectors into a third plurality of tokens; detokenize the third plurality of tokens into third text data; and convert the third text data into modified program code for generating the second version of the resource.

Clause 54: The computer program product of any of clauses 41-53, wherein the resource comprises at least one of a webpage, a mobile app, and/or a gaming environment.

Clause 55: The computer program product of any of clauses 41-54, wherein generating the first version and/or the second version of the resource comprises generating and rendering the first version and/or the second version of the resource.

Clause 56: The computer program product of any of clauses 41-55, wherein the at least one processor is further configured to: input the interaction data into a first machine learning model configured to generate associations between user interaction types from the interaction data and display update actions, the first machine learning model configured to generate at least one display update action for the second version of the resource; and generate, by a second machine learning model, a third version of the resource based on the at least one display update action for the second version of the resource, the third version of the resource displayed on the user device.

Clause 57: The computer program product of any of clauses 41-56, the at least one processor further configured to: input the at least one display update action for the second version of the resource and the program code into the second machine learning model configured to modify the program code based on the at least one display update action for the second version of the resource; and receive modified program code to effect the at least one display update action for the second version of the resource, wherein the third version of the resource is generated based on the modified program code.

Clause 58: The computer program product of any of clauses 41-57, wherein when inputting the interaction data into the first machine learning model, the at least one processor is configured to: parse the collected interaction data into fourth text data; tokenize the fourth text data to produce a fourth plurality of tokens; and encode the fourth plurality of tokens into a fourth plurality of vectors, the fourth plurality of vectors being input to the first machine learning model.

Clause 59: The computer program product of any of clauses 41-58, the at least one processor configured to: input the content from the second version of the resource into the first machine learning model by: parsing the content of the second version of the resource back into third text data; tokenizing the third text data to produce the third plurality of tokens; and encoding the third plurality of tokens into the third plurality of vectors, the third plurality of vectors being input to the first machine learning model.

Clause 60: The computer program product of any of clauses 41-59, wherein the first machine learning model is configured to combine the fourth plurality of vectors and the third plurality of vectors to produce a fifth plurality of vectors, the fifth plurality of vectors corresponding to input used to generate the third version of the resource.

These and other features and characteristics of the present disclosure, as well as the methods of operation and functions of the related elements of structures and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the disclosed subject matter.

### BRIEF DESCRIPTION OF THE DRAWINGS

Additional advantages and details are explained in greater detail below with reference to the non-limiting, exemplary embodiments that are illustrated in the accompanying schematic figures, in which:

FIG. 1 is a schematic diagram of a system for generating a customized user interface based on user interactions, according to some non-limiting embodiments or aspects;

FIG. 2 is a schematic diagram of a system for generating a customized user interface based on user interactions, according to some non-limiting embodiments or aspects;

FIG. 3 is a schematic diagram of a system for generating a customized user interface based on user interactions, according to some non-limiting embodiments or aspects;

FIG. 4 is a schematic diagram of a system for generating a customized user interface based on user interactions, according to some non-limiting embodiments or aspects;

FIG. 5 is a flow diagram of a method for generating a customized user interface based on user interactions, according to some non-limiting embodiments or aspects;

FIG. 6 is a flow diagram of a method for generating a customized user interface based on user interactions, according to some non-limiting embodiments or aspects;

FIG. 7 is a flow diagram of a method for accessing a resource, according to some non-limiting embodiments or aspects;

FIG. 8A is a flow diagram of a method for preparing inputs to a machine learning model, according to some non-limiting embodiments or aspects;

FIG. 8B is a flow diagram of a method for preparing inputs to a rendering model, according to some non-limiting embodiments or aspects;

FIG. 9 is an example user interface having a first font size (e.g., a first version), according to some non-limiting embodiments or aspects;

FIG. 10 is an example of the user interface of FIG. 9 having a second font size (e.g., a second version), according to some non-limiting embodiments or aspects;

FIG. 11 is a schematic diagram of an example environment in which methods, systems, and/or computer program products described herein may be implemented, according to some non-limiting embodiments or aspects; and

FIG. 12 is a schematic diagram of example components of one or more devices of FIGS. 1-3 and 9-11, according to some non-limiting embodiments or aspects.

### DETAILED DESCRIPTION

For purposes of the description hereinafter, the terms “end,” “upper,” “lower,” “right,” “left,” “vertical,” “horizontal,” “top,” “bottom,” “lateral,” “longitudinal,” and derivatives thereof shall relate to the embodiments as they are oriented in the drawing figures. However, it is to be understood that the embodiments may assume various alternative variations and step sequences, except where expressly specified to the contrary. It is also to be understood that the specific devices and processes illustrated in the attached drawings, and described in the following specification, are simply exemplary embodiments or aspects of the disclosed subject matter. Hence, specific dimensions and other physical characteristics related to the embodiments or aspects disclosed herein are not to be considered as limiting.

Some non-limiting embodiments or aspects may be described herein in connection with thresholds. As used herein, satisfying a threshold may refer to a value being greater than the threshold, more than the threshold, higher than the threshold, greater than or equal to the threshold, less than the threshold, fewer than the threshold, lower than the threshold, less than or equal to the threshold, equal to the threshold, etc.

No aspect, component, element, structure, act, step, function, instruction, and/or the like used herein should be construed as critical or essential unless explicitly described as such. Also, as used herein, the articles “a” and “an” are intended to include one or more items and may be used interchangeably with “one or more” and “at least one.” Furthermore, as used herein, the term “set” is intended to include one or more items (e.g., related items, unrelated items, a combination of related and unrelated items, and/or the like) and may be used interchangeably with “one or more” or “at least one.” Where only one item is intended, the term “one” or similar language is used. Also, as used herein, the terms “has,” “have,” “having,” or the like are intended to be open-ended terms. Further, the phrase “based on” is intended to mean “based at least partially on” unless explicitly stated otherwise. In addition, reference to an action being “based on” a condition may refer to the action being “in response to” the condition. For example, the phrases “based on” and “in response to” may, in some non-limiting embodiments or aspects, refer to a condition for automatically triggering an action (e.g., a specific operation of an electronic device, such as a computing device, a processor, and/or the like).

As used herein, the term “account identifier” may include one or more primary account numbers (PANs), tokens, or other identifiers associated with a customer account. The term “token” may refer to an identifier that is used as a substitute or replacement identifier for an original account identifier, such as a PAN. Account identifiers may be alphanumeric or any combination of characters and/or symbols. Tokens may be associated with a PAN or other original account identifier in one or more data structures (e.g., one or more databases, and/or the like) such that they may be used to conduct a transaction without directly using the original account identifier. In some examples, an original account identifier, such as a PAN, may be associated with a plurality of tokens for different individuals or purposes.

As used herein, the term “acquirer institution” may refer to an entity licensed and/or approved by a transaction service provider to originate transactions (e.g., payment transactions) using a payment device associated with the transaction service provider. The transactions the acquirer institution may originate may include payment transactions (e.g., purchases, original credit transactions (OCTs), account funding transactions (AFTs), and/or the like). In some non-limiting embodiments or aspects, an acquirer institution may be a financial institution, such as a bank. As used herein, the term “acquirer system” may refer to one or more computing devices operated by or on behalf of an acquirer institution, such as a server computer executing one or more software applications.

As used herein, the terms “client” and “client device” may refer to one or more client-side devices or systems (e.g., remote from a transaction service provider) used to initiate or facilitate a transaction (e.g., a payment transaction). As an example, a “client device” may refer to one or more point-of-sale (POS) devices used by a merchant, one or more acquirer host computers used by an acquirer, one or more mobile devices used by a user, and/or the like. In some non-limiting embodiments or aspects, a client device may be an electronic device configured to communicate with one or more networks and initiate or facilitate transactions. For example, a client device may include one or more computers, portable computers, laptop computers, tablet computers, mobile devices, cellular phones, wearable devices (e.g., watches, glasses, lenses, clothing, and/or the like), personal digital assistants (PDAs), and/or the like. Moreover, a “client” may also refer to an entity (e.g., a merchant, an acquirer, and/or the like) that owns, utilizes, and/or operates a client device for initiating transactions (e.g., for initiating transactions with a transaction service provider).

As used herein, the term “communication” may refer to the reception, receipt, transmission, transfer, provision, and/or the like of data (e.g., information, signals, messages, instructions, commands, and/or the like). For one unit (e.g., a device, a system, a component of a device or system, combinations thereof, and/or the like) to be in communication with another unit means that the one unit is able to directly or indirectly receive information from and/or transmit information to the other unit. This may refer to a direct or indirect connection (e.g., a direct communication connection, an indirect communication connection, and/or the like) that is wired and/or wireless in nature. Additionally, two units may be in communication with each other even though the information transmitted may be modified, processed, relayed, and/or routed between the first and second unit. For example, a first unit may be in communication with a second unit even though the first unit passively receives information and does not actively transmit information to the second unit. As another example, a first unit may be in communication with a second unit if at least one intermediary unit processes information received from the first unit and communicates the processed information to the second unit. In some non-limiting embodiments or aspects, a message may refer to a network packet (e.g., a data packet and/or the like) that includes data. It will be appreciated that numerous other arrangements are possible.

As used herein, the term “computing device” or “user device” may refer to one or more electronic devices configured to process data. A computing device may, in some examples, include the necessary components to receive, process, and output data, such as a processor, a display, a memory, an input device, a network interface, and/or the like. A computing device may be a mobile device. As an example, a mobile device may include a cellular phone (e.g., a smartphone or standard cellular phone), a portable computer, a wearable device (e.g., watches, glasses, lenses, clothing, and/or the like), a PDA, and/or other like devices. A computing device may also be a desktop computer or other form of non-mobile computer.

As used herein, the terms “electronic wallet” and “electronic wallet application” refer to one or more electronic devices and/or software applications configured to initiate and/or conduct payment transactions. For example, an electronic wallet may include a mobile device executing an electronic wallet application, and may further include server-side software and/or databases for maintaining and providing transaction data to the mobile device. An “electronic wallet provider” may include an entity that provides and/or maintains an electronic wallet for a customer, such as Google Pay®, Android Pay®, Apple Pay®, Samsung Pay®, and/or other like electronic payment systems. In some non-limiting examples, an issuer bank may be an electronic wallet provider.

As used herein, the term “issuer institution” may refer to one or more entities, such as a bank, that provide accounts to customers for conducting transactions (e.g., payment transactions), such as initiating credit and/or debit payments. For example, an issuer institution may provide an account identifier, such as a PAN, to a customer that uniquely identifies one or more accounts associated with that customer. The account identifier may be embodied on a portable financial device, such as a physical financial instrument, e.g., a payment card, and/or may be electronic and used for electronic payments. The term “issuer system” refers to one or more computer devices operated by or on behalf of an issuer institution, such as a server computer executing one or more software applications. For example, an issuer system may include one or more authorization servers for authorizing a transaction.

As used herein, the term “merchant” may refer to an individual or entity that provides goods and/or services, or access to goods and/or services, to customers based on a transaction, such as a payment transaction. The term “merchant” or “merchant system” may also refer to one or more computer systems operated by or on behalf of a merchant, such as a server computer executing one or more software applications.

As used herein, the term “payment device” may refer to an electronic payment device, a portable financial device, a payment card (e.g., a credit or debit card), a gift card, a smartcard, smart media, a payroll card, a healthcare card, a wristband, a machine-readable medium containing account information, a keychain device or fob, a radio frequency identification (RFID) transponder, a retailer discount or loyalty card, a cellular phone, an electronic wallet mobile application, a PDA, a pager, a security card, a computing device, an access card, a wireless terminal, a transponder, and/or the like. In some non-limiting embodiments or aspects, the payment device may include volatile or non-volatile memory to store information (e.g., an account identifier, a name of the account holder, and/or the like).

As used herein, the term “payment gateway” may refer to an entity and/or a payment processing system operated by or on behalf of such an entity (e.g., a merchant service provider, a payment service provider, a payment facilitator, a payment facilitator that contracts with an acquirer, a payment aggregator, and/or the like), which provides payment services (e.g., transaction service provider payment services, payment processing services, and/or the like) to one or more merchants. The payment services may be associated with the use of portable financial devices managed by a transaction service provider. As used herein, the term “payment gateway system” may refer to one or more computer systems, computer devices, servers, groups of servers, and/or the like, operated by or on behalf of a payment gateway.

As used herein, a “point-of-sale (POS) device” may refer to one or more devices, which may be used by a merchant to conduct a transaction (e.g., a payment transaction) and/or process a transaction. For example, a POS device may include one or more client devices. Additionally or alternatively, a POS device may include peripheral devices, card readers, scanning devices (e.g., code scanners), Bluetooth® communication receivers, near-field communication (NFC) receivers, RFID receivers, and/or other contactless transceivers or receivers, contact-based receivers, payment terminals, and/or the like. As used herein, a “point-of-sale (POS) system” may refer to one or more client devices and/or peripheral devices used by a merchant to conduct a transaction. For example, a POS system may include one or more POS devices and/or other like devices that may be used to conduct a payment transaction. In some non-limiting embodiments or aspects, a POS system (e.g., a merchant POS system) may include one or more server computers configured to process online payment transactions through webpages, mobile applications, and/or the like.

As used herein, “processor” may represent any type of processing unit, such as a single processor having one or more cores, one or more cores of one or more processors, multiple processors each having one or more cores, and/or other arrangements and combinations of processing units. Reference to “at least one processor” can refer to a previously-recited processor or a different processor.

As used herein, “real-time” or “near real-time” may refer to a system in which an action is performed nearly immediately (e.g., within seconds, milliseconds, less than a minute, and the like) with respect to another action or event. For example, for a system generating a customized user interface based on user interactions, the customized user interface may be displayed nearly immediately following the user interaction that triggers the customized update to the display of the user interface. For example, the customized user interface may be displayed in response to the user interaction and while the user is still viewing the same content displayed on the original user interface.

As used herein, the term “server” may refer to or include one or more computing devices that are operated by or facilitate communication and processing for multiple parties in a network environment, such as the Internet, although it will be appreciated that communication may be facilitated over one or more public or private network environments and that various other arrangements are possible. Further, multiple computing devices (e.g., servers, POS devices, mobile devices, etc.) directly or indirectly communicating in the network environment may constitute a “system.”

As used herein, the term “system” may refer to one or more computing devices or combinations of computing devices (e.g., processors, servers, client devices, software applications, components of such, and/or the like). Reference to “a device,” “a server,” “a processor,” and/or the like, as used herein, may refer to a previously-recited device, server, or processor that is recited as performing a previous step or function, a different device, server, or processor, and/or a combination of devices, servers, and/or processors. For example, as used in the specification and the claims, a first device, a first server, or a first processor that is recited as performing a first step or a first function may refer to the same or different device, server, or processor recited as performing a second step or a second function.

As used herein, the term “transaction service provider” may refer to an entity that receives transaction authorization requests from merchants or other entities and provides guarantees of payment, in some cases through an agreement between the transaction service provider and an issuer institution. For example, a transaction service provider may include a payment network such as Visa® or any other entity that processes transactions. The term “transaction processing system” may refer to one or more computer systems operated by or on behalf of a transaction service provider, such as a transaction processing server executing one or more software applications. A transaction processing server may include one or more processors and, in some non-limiting embodiments or aspects, may be operated by or on behalf of a transaction service provider.

Non-limiting embodiments or aspects of the disclosed subject matter are directed to systems, methods, and computer program products for generating a customized user interface based on user interactions. The customized user interface may be generated based on individual requirements using generative artificial intelligence (AI). For example, use of generative Al to generate and display customized interfaces for users based on their interaction with the interface is provided. Such systems may have the ability to automatically sense user feedback based on how the user is interacting with the present user interface and determine how the present interface may be improved and updated to address certain issues that the user has with the interface.

The present disclosure provides a system that can provide real-time customization of an interactive interface. The customization may rely on automatically sensing user interaction with a current interface. The customization may further rely on using one or more machine-learning models (e.g., a generative AI model) to determine a problem a user is having with the current interface based on the user interactions. The customization may, thereafter, include a modification to the current interface based on a determined or detected problem and a recommendation provided by the generative AI. In some non-limiting embodiments or aspects, the user interaction may be continuously and/or continually sensed, resulting in a constant feedback loop for the interface. In such non-limiting embodiments or aspects, the user interface may be constantly updating, providing the user with a more favorable or improved experience using the interface. The system may automatically (e.g., using a machine learning model) generate the program code used to render the modified user interface. This is especially beneficial for users that may not be able to access traditional interfaces easily, including, for example, disabled users or users that do not speak the language provided by the interface.

Additional benefits associated with systems and methods disclosed herein include, for example, increased efficiency in developing interfaces that are customizable to support the needs of different individuals; the generation of a flexible product that conforms to the needs of multiple different people with special needs, as well as products that are adaptable based on individuals' needs; production of more inclusive products that can be seamlessly used by a wide variety of individuals; and improved adoption of the user interface across different geographies.

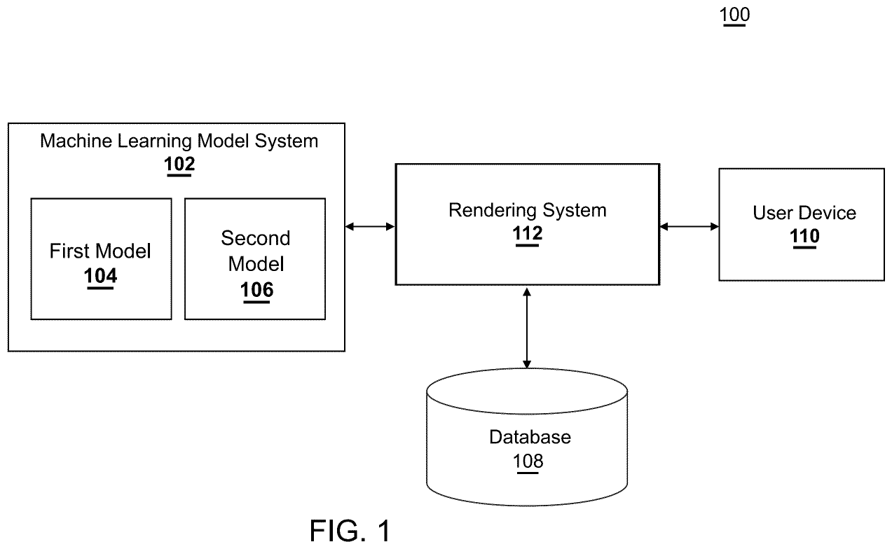

Referring now to FIG. 1, shown is an example system 100 for generating a customized user interface based on user interactions, according to some non-limiting embodiments or aspects. For example, system 100 may include machine learning model system 102, a database 108, a user device 110, and/or rendering system 112.

Machine learning model system 102 may include one or more devices capable of receiving information from and/or communicating information to database 108, user device 110, and/or rendering system 112. For example, machine learning model system 102 may include a computing device, such as a server, a group of servers, a desktop computer, a portable computer, a mobile device, and/or other like devices. In some non-limiting embodiments or aspects, machine learning model system 102 may include a data storage device (e.g., database 108). In some non-limiting embodiments or aspects, machine learning model system 102 may be capable of receiving information from, storing information in, communicating information to, or searching information stored in the data storage device (e.g., database 108).

In some non-limiting embodiments or aspects, machine learning model system 102 may include a first machine learning model 104 and/or a second machine learning model 106. In some non-limiting embodiments or aspects, first machine learning model 104 and/or second machine learning model 106 may include one or more machine learning models. In some non-limiting embodiments or aspects, the first machine learning model 104 and the second machine learning model 106 may be the same machine learning model or may be separate machine learning models. An output of the first machine learning model 104 may be an input to the second machine learning model 106.

In some non-limiting embodiments or aspects, first machine learning model 104 and/or second machine learning model 106 includes a generative machine leaning model. As is known, generative machine learning models (and/or generative Al models) may by trained based on a particular type of data to generate new data of that type. For example, a large language model (LLM) may be trained based on text data to generate data (e.g., predict the next word(s) or next sentence(s), predict a desired user modification to a user interface, and/or the like). In some non-limiting embodiments or aspects, first machine learning model 104 and/or second machine learning model 106 includes an LLM. In some non-limiting embodiments or aspects, first machine learning model 104 and/or second machine learning model 106 may include a transformer model in which text may be converted to a numerical representation (e.g., a token), and each token may be converted into a vector.

In some non-limiting embodiments or aspects, machine learning model system 102 may generate (e.g., train, validate, retrain, and/or the like), store, and/or implement (e.g., operate, provide inputs to and/or outputs from, and/or the like) one or more machine learning models, such as first machine learning model 104 and/or second machine learning model 106. For example, machine learning model system 102 may include a computing device, such as a server, a group of servers, a desktop computer, a portable computer, a mobile device, and/or other like devices.

In some non-limiting embodiments or aspects, machine learning model system 102 may be in communication with a data storage device, which may be local or remote to machine learning model system 102. In some non-limiting embodiments or aspects, machine learning model system 102 may be capable of receiving information from, storing information in, transmitting information to, and/or searching information stored in database 108, user device 110, and/or rendering system 112.

Database 108 may include one or more devices capable of receiving information from and/or communicating information to machine learning model system 102, user device 110, and/or rendering system 112. For example, database 108 may include a computing device, such as a server, a group of servers, a desktop computer, a portable computer, a mobile device, and/or other like devices. In some non-limiting embodiments or aspects, database 108 may include a data storage device. In some non-limiting embodiments or aspects, database 108 may be capable of receiving information from, storing information in, communicating information to, or searching information stored in the data storage device. In some non-limiting embodiments or aspects, database 108 may be part of machine learning model system 102 and/or part of the same system as machine learning model system 102.

User device 110 may include one or more devices capable of receiving information from and/or communicating information to machine learning model system 102 and/or database 108 (e.g., directly via wired or wireless communication connection, indirectly via rendering system 112, and/or the like). For example, user device 110 may include a computing device, such as a mobile device, a portable computer, a desktop computer, and/or other like devices. The user device 110 may comprise a mobile device (e.g., a smartphone or tablet) comprising a user interface. Additionally or alternatively, each user device 110 may include a device capable of receiving information from and/or communicating information to other user devices 110.

Rendering system 112 may include one or more devices capable of receiving information from and/or communicating information to machine learning model system 102, database 108, and/or user device 110. For example, rendering system 112 may include a computing device, such as a server, a group of servers, a desktop computer, a portable computer, a mobile device, and/or other like devices. In some non-limiting embodiments or aspects, rendering system 112 may be configured to retrieve data stored in database 108, the data configured to cause display of a user interface on user device 110. In some non-limiting embodiments or aspects, rendering system 112 may be configured to render (e.g., display) and/or re-render (e.g., modify a display) data on a user interface of user device 110.

Rendering system 112 may include one or more wired and/or wireless servers or networks. For example, rendering system 112 may include a cellular network (e.g., a long-term evolution (LTE®) network, a third generation (3G) network, a fourth generation (4G) network, a fifth generation (5G) network, a code division multiple access (CDMA) network, and/or the like), a public land mobile network (PLMN), a local area network (LAN), a wide area network (WAN), a metropolitan area network (MAN), a telephone network (e.g., the public switched telephone network (PSTN)), a private network (e.g., a private network associated with a transaction service provider), an ad hoc network, an intranet, the Internet, a fiber optic-based network, a cloud computing network, and/or the like, and/or a combination of these or other types of networks. Rendering system 112 may not include one or more wired and/or wireless servers or networks, but may communicate with other components in system 100 (e.g., machine learning model system 102, database 108, user device 110, and/or the like) over one or more wired and/or wireless servers or networks.

In some non-limiting embodiments or aspects, rendering system 112 provides a rendering service to a user by providing a rendered version of a requested resource. For example, a user may request a resource and the rendering system 112 may provide the resource to the user. The rendered resource may be the original resource or a modified resource, as will be explained in greater detail below. Rendering the resource may comprise displaying the resource on user device 110.

The number and arrangement of systems and devices shown in FIG. 1 are provided as an example. There may be additional systems and/or devices, fewer systems and/or devices, different systems and/or devices, and/or differently arranged systems and/or devices than those shown in FIG. 1. Furthermore, two or more systems or devices shown in FIG. 1 may be implemented within a single system or device, or a single system or device shown in FIG. 1 may be implemented as multiple, distributed systems or devices. Additionally or alternatively, a set of systems (e.g., one or more systems) or a set of devices (e.g., one or more devices) of system 100 may perform one or more functions described as being performed by another set of systems or another set of devices of system 100.

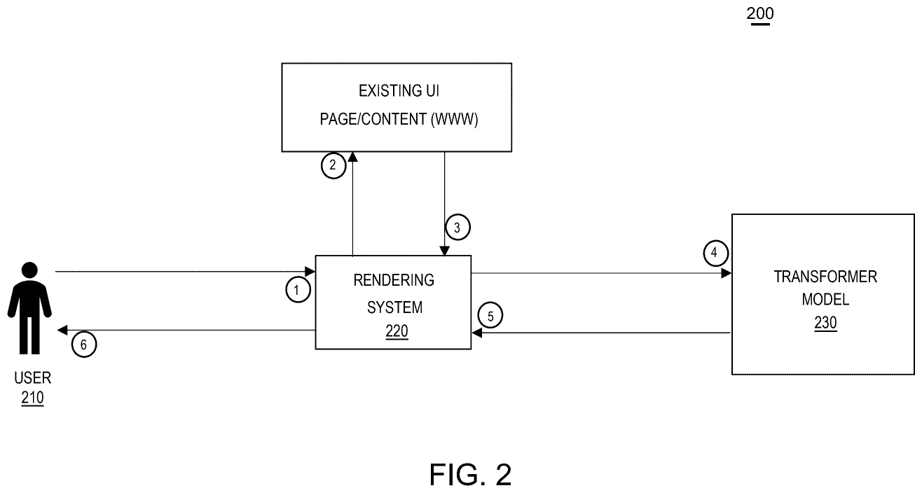

Referring now to FIG. 2, a schematic diagram of a system 200 is shown for generating a customized user interface based on user interactions, according to some non-limiting embodiments or aspects. In some non-limiting embodiments or aspects, a step shown in the system 200 may be automatically performed in response to performance and/or completion of a prior step. For example, system 200 may include a rendering system 220 and a transformer or machine learning model 230. Rendering system 220 may include a rendering model and/or rendering service that is configured to render an output of a resource for a user of the user device 210. Transformer or machine learning model 230 may be configured to provide an updated output of a resource that is provided to rendering system 220.

As shown by step 1, in some embodiments, the user device 210 of a user generates a request to access a resource. The resource may be a webpage or website, an app, a game, a virtual environment, and/or the like, but generally includes a user interface (UI). The UI may be a graphical UI, a command line UI, or a menu-driven UI, among others.

Thus, as part of this example, the user device 210 may request access to a particular webpage. As part of the request, the user device 210 may specify one or more preferences related to how the webpage is rendered. For example, preferences may include the specifics of the UI formatting, such as typography, color, language, module design, and the like. The preferences may be provided by and/or determined by the user device 210 prior to accessing the resource. For example, the user device 210 may determine one or more preferences and communicate the one or more preferences to rendering system 220, which may store (e.g. in database 108 from FIG. 1) the user preferences. The user device 210 may send user preferences to the rendering system 220 prior to a request to access a resource and/or the user device 210 may send user preferences to the rendering system 220 substantially simultaneously with the request to access a resource. The resource may be rendered based at least in part on the user preferences.

At steps 2 and 3, upon receiving the user's request to access a resource, rendering system 220 may retrieve an un-customized or raw resource for the user. The un-customized or raw resource for the user may comprise a program code for rendering the resource. The rendering system 220 may retrieve the un-customized or raw resource from a database (e.g., database 108). The rendering system 220 may optionally retrieve one or more stored user preferences (e.g., predetermined user preferences) specifying how to modify and display the resource. In some non-limiting embodiments or aspects, the rendering system 220 may intercept the user's request to access the resource. For example, in the case of requesting a webpage, the rendering system 220 may retrieve the webpage for the user device 210.

At step 4, before transmitting the raw resource directly back to the user (e.g., by displaying the resource on user device 210), the rendering system 220 may communicate or interact with the transformer model 230. In some non-limiting embodiments or aspects, the rendering system 220 may provide the raw resource and one or more user preferences to the transformer model 230. The transformer model 230 may be any suitable machine learning model that can be trained to create or render a customized form or version of the raw resource request. For example, in some embodiments, transformer model 230 may include a generative model that is trained on performing this task of rendering/creating a customized form of the raw request. For example, transformer model 230 may generate a modified program code configured to render a modified version of the resource.

At step 5, transformer model 230 may generate a customized resource from the raw resource and transmit the customized resource as a response or reply to the rendering system 220. At step 6, rendering system 220 may respond to the resource request of the user device 210 with the customized resource. The response of the rendering system 220 may cause the customized resource to be displayed on a user interface of the user device 210, such as by executing the program code associated with displaying the customized resource.

In some non-limiting embodiments or aspects, the customization of the presented resource is not a one-time activity, nor is it static. Instead, a dynamic feedback loop may be implemented or provided, and re-rendering of the customized resource (a modified version thereof) based on feedback from the user is provided. Thus, customization of the resource (and modification thereof) may be executed as a periodic and/or continuous and/or continual process. A continuous process refers to a process that continues without interruption or ceasing during a time period. A continual process refers to a process that recurs frequently or regularly during the time period.

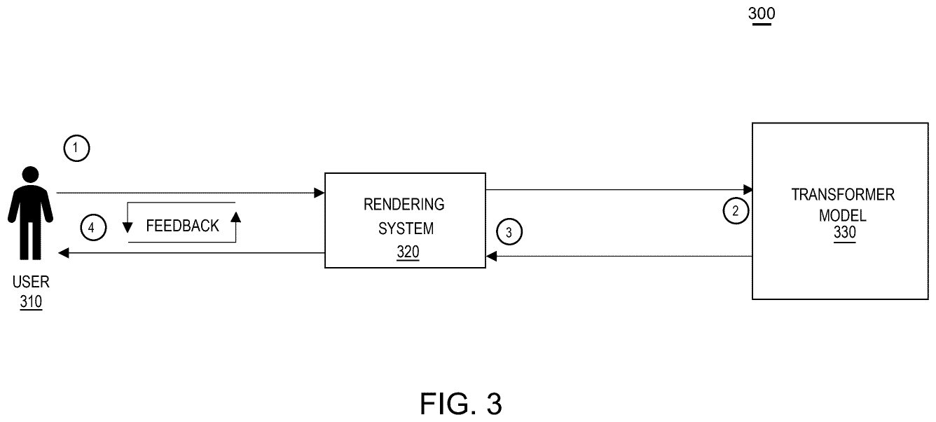

Referring now to FIG. 3, a schematic diagram of a system 300 is shown for generating a customized user interface based on user interactions, according to some non-limiting embodiments or aspects. In some non-limiting embodiments or aspects, a step shown in the system 300 may be automatically performed in response to performance and/or completion of a prior step. For example, the system 300 may include a rendering system 320 and a transformer or machine learning model 330. Rendering system 320 may include a rendering model and/or rendering service that is configured to render an output of a resource for the user device 310. Transformer or machine learning model 330 may be configured to provide an updated output of a resource (e.g., of a previously rendered resource) that is provided to rendering system 320.

As shown by step 1, in some non-limiting embodiments or aspects, once the customized resource based on the initial customization requested by the user is presented to the user device 310, the rendering system 320 may monitor (e.g., continuously and/or continually monitor) for any feedback based on user interaction. Based on the feedback based on user interaction, a modified version of the resource may be rendered, and the modified version of the resource may be rendered in real-time or near real-time.

The feedback that the user device 310 provides can either be explicit, where the user device 310 explicitly requests further customization, or the feedback can be implicit, where the rendering system or service 320 intelligently automatically senses and/or infers difficulties experienced by a user of the user device 310 and prompts the transformer model 330 to further customize/enhance the presented resource to address the problem the user of the user device 310 is experiencing. For example, as part of explicit feedback, the user can demand customization if he/she is experiencing difficulty with certain parts of the product. Alternatively, the rendering system 320 can automatically detect subtle implicit feedback based on, e.g., user interaction patterns associated with how the user interacts with the user device 310. In this way, the rendering service may collect interaction data of the user of the user device 310 (e.g., collect interaction data as to how the user interacts with the rendered, first version of the user interface).

In response to the rendering system 320 receiving and/or detecting feedback events, at step 2, the rendering system 320 communicates or interacts with the transformer model 330. The rendering system 320 may input the collected interaction data to the transformer model 330. This communication may provide a request to enhance re-rendering based on the collected interaction data. In some non-limiting embodiments or aspects, the transformer model 330 may be trained to render customized resources, such as customized web pages or interfaces, based on interaction data. For example, the transformer model 330 may be trained on interaction data and how certain interaction data indicates a problem experienced by the user of an interface. The transformer model 330 may be trained on how problems experienced by the user of an interface may be remedied by making one or more modifications to the user interface. Therefore, the transformer model 330 may be trained to receive an input with interaction data and generate an output including one or more modifications to address a problem experienced by the user indicated by the interaction data (e.g., by outputting the program code to modify the user interface).

At step 3, the transformer model 330 responds to rendering system 320 with an improved re-rendered resource. This improved re-rendered resource may include a further customized rendered resource that enhances a user's experience.

At step 4, the rendering system 320 provides the customized resource with enhancements to the user device 310 to cause the modified resource to be displayed thereby. As shown in FIG. 3, the resource in system 300 may be a customized user interface page. However, the resource may be any suitable resource, such as a webpage or website, an app, a game, a virtual environment, etc.

In some non-limiting embodiments or aspects, the interaction shown in FIG. 3 is a continuous and/or continual interaction, where the rendering system or service 320 continues capturing user feedback implicitly and/or explicitly. Upon capturing user feedback, the rendering system or service 320 continues to communicate with the transformer model 330 to further enhance the user experience by providing even finer-tuned customization until the user interaction is completed, thereby creating a continuous and/or continual feedback loop that improves user experience in real-time or near real-time by providing a highly customized experience.

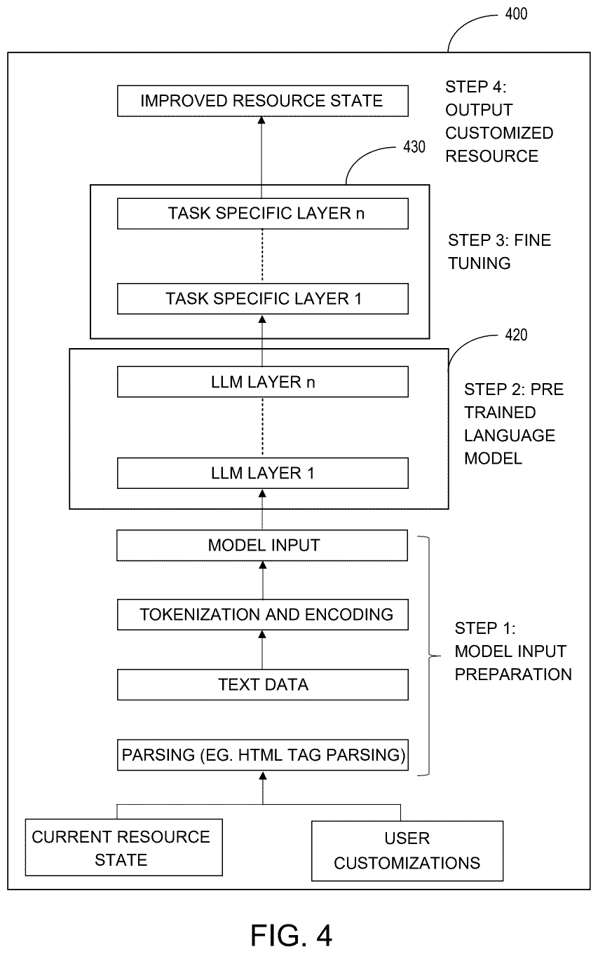

Referring now to FIG. 4, system 400 is shown for generating a customized user interface based on user interactions, according to some non-limiting embodiments or aspects. FIG. 4 includes a general architecture of the system, which may comprise the machine learning model system 102 (as shown in FIG. 1).

In some non-limiting embodiments or aspects, system 400 includes a first machine learning model 420 and a second machine learning model 430. First machine learning model 420 may be a large language model (LLM), for example, trained to render customized pages. In some non-limiting embodiments or aspects, the LLM may be pre-trained on a variety of different texts and codebases and output one or more display update actions. The first machine learning model 420 may receive the interaction data (of how the user interactions with the first version of the resource) and generate associations between user interaction types from the interaction data and display update actions. The first machine learning model 420 may generate at least one display update action for the second version of the resource (e.g., how to modify the first version of the resource).

Second machine learning model 430 may be any machine learning model capable of generating the second version of the resource to be rendered for the user. Second machine learning model 430 may be configured to generate and/or modify the program code, such that the outputted program code, when executed by the user device, is configured to cause display of the updated version of the resource.

In FIG. 4, a series of steps executed by system 400 may be provided that enable the system to generate the improved, renderable resource. In step 0, the input for the entire flow is provided as one or more inputs. For example, as shown, dual inputs may be provided; input 1 may be the current state of the resource (e.g., current program code of the resource) that a user is interacting with, and input 2 may be the user customizations that are currently in place and/or interaction data that may be used (by system 400) to suggest user customizations to the present resource.

Referring briefly to FIGS. 1 and 2, if the user is interacting with system 100 for the very first time, the current resource state (input 1) may be predominantly a static (e.g., default) resource, and the user customizations (input 2) may be a set of predetermined preferences that the user would identify before starting their interaction with system 100. For example, a person with a visual disability might set initial preferences to convert every navigation into hearing signals.

However, as the interaction continues, as shown in FIG. 3, rendering system 320 may provide, e.g., real-time, feedback to the transformer model 330 by encapsulating signals in the user customizations, focusing on areas where either the user has been stuck or is struggling; for example, if the user has searched for the term “Customer Care” more than three times and is still trying to figure out the way to get to it.

Subtle signals like this, which act as soft indicators to a struggle in interaction with the system from user's perspective, may allow transformer model 330 to further improve its customized output as it would have been trained on similar use cases in addition to building on top of the knowledge of the LLMs. In some non-limiting embodiments or aspects, the LLM is assumed to inherently understand complex correlations between a variety of such data points, like the one in this example and, therefore, will have a much better and accurate capability to correctly interpret such signals.

Now referring back to FIG. 4, at step 1, the input to the first machine learning model 420 may be prepared. The first machine learning model 420 may be an LLM. In some non-limiting embodiments or aspects, a focus of the present disclosure may be on improving user experience, while interacting with any interactive interface. However, because LLMs excel in understanding and operating on natural language, a method or system may convert data collected in the interaction data to natural language data, such that LLMs are able to more efficiently analyze the data and provide more accurate display update actions.

Therefore, to bridge this gap, the following input conversion steps may be performed: parsing, tokenization, and encoding. In some non-limiting embodiments or aspects, the parsing may comprise HTML tag parsing (e.g., of the program code) to text. Thus, it is to be understood that the parsing is performed on the user interface data (current resource state) and any updated customizations (user customizations) to convert the information into text data. Thereafter, the text data may be converted into tokens (e.g., a numerical representation) by a tokenizer. Each token may be then mapped to a unique ID based on a vocabulary file that the tokenizer uses. Encoding may convert the tokens into token IDs. In some non-limiting embodiments or aspects, the token IDs may be in vector form. Therefore, once these operations are successfully executed, the data may be in vector form (ex. [0.1 0.8 0.9 . . . 0.5 . . . 0.7 0.9]) ready to be input into the LLM (the first machine learning model 420).

At step 2, the model input may be fed into the LLM, which processes them to perform tasks like translation, question-answering, or text generation. In some non-limiting embodiments or aspects, because the input data includes both the current resource state (input 1) and the signal indicating what customization the user may want (e.g., based on user interaction data) (input 2), the LLM may be able to generate correlations between the two inputs and provide potential enhancements in the resource state so that the state is more aligned with the customizations. The LLM may generate at least one display update action based on these correlations, which the display update action represents at least one modification to make to the user interface to improve the user interface based on the interaction data.

As an example, if the rendering system automatically detects based on interaction data that the user is struggling with the font size of the rendered resource, the input to the LLM before the pre-processing of step 0 may look something like below:
Current State: <start-text size=3>This is a sample text that is rendered on an interface <end-text>
Customization: feedback-signal: struggling with font size.

However, the output of the LLM would be a generalized output (e.g., in natural language or a combination of natural language and code), whereas a very specific format may be required for rendering the user interface to the user. Therefore, to achieve the specialized format, a few layers may be added as part of fine-tuning the model.

Referring back to the above input, the output of the LLM model may look something like below. It should be appreciated that in reality, the output may just be a set of numerical vectors in some intermediate representation.
LLM Output: <start-text size=6>This is a sample text that is rendered on an interface <end-text>

At step 3, the fine-tuning model (the second machine learning model 430) takes the output of the LLM as input, which can be a combination of text and code (which is essentially text) and can be trained to output data in a format which can be understood by rendering system 320 and can optionally be shown to the user. The output may comprise the program code to effect the display update action generated by the first machine learning model 420.

The output of the fine-tuning model for the LLM input may look something like below:

### Fine Tuning Model Output:

<Start-of-Resource>
   <Start-Text-Block>
      <Start-Text>
      <Properties: SIZE: 6 COLOR: BLACK . . . >
      <End-Text>
   <End-Text-Block>
<End-of-Resource>

As shown in step 4, the output of the fine tuning model may be used (e.g., by the rendering system) to generate the improved resource, such as by executing the program code to cause display of the improved resource.

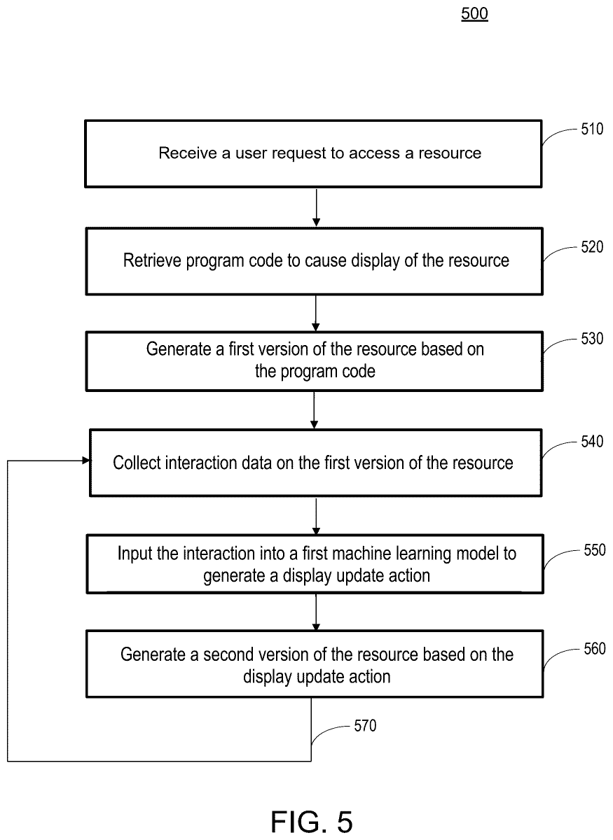

Referring now to FIG. 5, a flow diagram of a method 500 for generating a customized user interface based on user interactions is shown, according to some non-limiting embodiments or aspects. The steps shown in FIG. 5 are for example purposes only. It will be appreciated that additional, fewer, different, and/or a different order of steps may be used in some non-limiting embodiments or aspects. In some non-limiting embodiments or aspects, a step may be automatically performed in response to performance and/or completion of a prior step. Method 500 includes a number of steps 510-560 that may be performed consecutively or in any order.

For example, at step 510, the rendering system may receive a user request to access a resource from a user on a user device. As provided in other examples, the user request may be for accessing a webpage, a video game or gaming environment, a mobile app, or any other resource available on the internet or local to the user's device. The user may request access to a resource by selecting a selectable option displayed on the user interface of the user device (e.g., selectable link).

At step 520, the rendering system may retrieve program code to cause display of the resource. For example, if accessing a website, the rendering system may reach out to the server hosting the website and request a copy or path to the website. In some non-limiting embodiments or aspects, the program code is provided to the rendering system that will allow it to render the website.

In other examples, the rendering system may receive a URL request in a browser to render a webpage. The rendering system may also receive at least one parameter related to how the webpage is rendered, for example, a particular language, using hearing signals, the brightness level, text style/font/size, arrangement of components, and the like.

At step 530, the rendering system may generate a version of the resource based on the program code. The initial version of the resource generated will herein be referred to as a first version of the resource, as it is understood that updated versions may be produced according to the teachings of the disclosure. In some non-limiting embodiments or aspects, the first version of the resource is rendered by the rendering system and provided to the user in response to the user request to access the resource. In some non-limiting embodiments or aspects, the first version of the resource may be based on one or more pre-defined user preferences previously stored in a database, but may not be based on collected interaction data.

For example, the first version of the resource may be displayed to the user on the user device. Thus, if the user requested access to a webpage, the webpage is displayed on the user interface of the user device.

At step 540, the rendering system may collect interaction data on the first version of the resource. The interaction data may be based on sensed interactions of the user with the displayed first version of the resource. In some non-limiting embodiments or aspects, the rendering system is configured to monitor sensed interactions of the user on the user device for a feedback event.

The sensed interactions of feedback events may be explicit or implicit. For example, the feedback event may be based on a user interaction pattern. Alternatively, the feedback event may be an explicit request from a user, such as a request through a help menu.

In some non-limiting embodiments or aspects, the feedback event may be an implicit request. For example, if the user device is aware of a disability of the user, e.g., through feedback or setting provided, then any implicit requests that may be needed to accommodate the user may be inferred. This may be consistent with regulations or guidance provided by the ADA. As a simplified example, if the user has broken his hand and cannot type or scroll, a voice command may be offered or implemented by the user device to allow the user access to resources. For example, the user device may become aware of an implicit request by automatically sensing an unusual way in which the user is interacting with the user device and/or user interface, such as by repeatedly zooming in to one or more sections of the user interface more often than an average user.

In some non-limiting embodiments or aspects, when monitoring user interactions, the monitoring may be performed continuously and/or continually, intermittently, at predesignated times, or any combination thereof.

In some non-limiting embodiments or aspects, the feedback event appears as a flag or pop-up to the user. In some non-limiting embodiments or aspects, the user may have the option of allowing or discarding the feedback event. In the cases where the feedback event is discarded, the rendering system may not use the discarded feedback event to update the resource in a subsequent version.

At step 550, the rendering system may input the interaction data on the first version of the resource into a first machine learning model to generate a display action update. The first machine learning model may be any model capable of and/or configured to generate associations between user interaction types from the interaction data and display update actions. For example, the first machine learning model may be an LLM.

In some non-limiting embodiments or aspects, the first machine learning model is configured to generate at least one display update action for the first version of the resource. It can be appreciated that in some situations, multiple display update actions may be generated for any version of a resource, however, when at least one display update action is provided, it may be used to generate an updated version of the resource.

At step 560, a second version of the resource is generated based on the display update action for the first version of the resource. In some non-limiting embodiments or aspects, a second machine learning model is used to generate the second version of the resource. For example, a second machine learning model may be configured to generate program code (e.g., html code) based on the display update action output by the first machine learning model.

In some non-limiting embodiments or aspects, the second version of the resource is displayed on the user device. The second version of the resource may be updated on the user device in real-time or near real-time from when the second version of the resource is generated or rendered by the rendering system and/or when the rendering system sensed a user interaction indicating that the update to the user interface should be made.

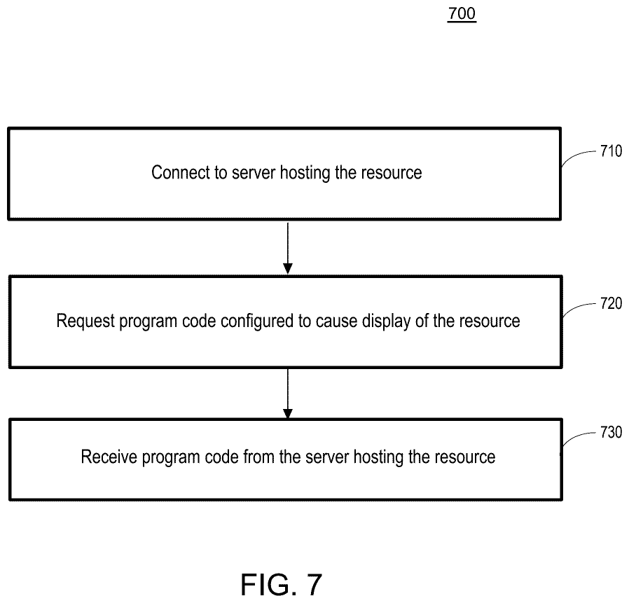

Referring now to FIG. 7, a flow diagram of a method 700 for accessing a resource is shown, according to some non-limiting embodiments or aspects. Method 700 provides further guidance on how steps 510 and/or 520 from FIG. 5 may operate. In some non-limiting embodiments or aspects, a step may be automatically performed in response to performance and/or completion of a prior step.

At steps 710 and 720, when retrieving the program code configured to cause display of the resource, the rendering system may connect to a server hosting the resource and request the program code configured to cause display of the resource. In requesting the program code, the rendering system may include at least one parameter related to how the resource is rendered. At step 730, the rendering system may receive a response including the program code from the server hosting the resource, which may be used to generate the first version of the resource.

It should be appreciated, that in some non-limiting embodiments or aspects, the first version of the resource includes at least one parameter related to how the resource is rendered. These parameters may be provided by the user when using the user device, such as in device settings and controls. In some non-limiting embodiments or aspects, the at least one parameter is separate and distinct from the feedback events provided in the disclosure.

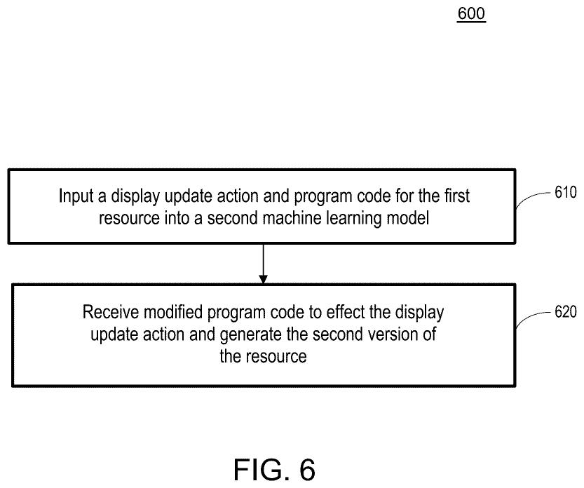

Referring now to FIG. 6, a flow diagram of a method 600 for generating a customized user interface based on user interactions is shown, according to some non-limiting embodiments or aspects. Method 600 provides further guidance on how step 560 from FIG. 5 may be operated. In some non-limiting embodiments or aspects, a step may be automatically performed in response to performance and/or completion of a prior step.

For example, at step 610, the rendering system may input a display update action and program code for the first resource into a second machine learning model. The second machine learning model may be configured to modify the program code based on the display update action for the first version of the resource.

At step 620, the rendering system receives modified program code to effect the at least one display update action for the first version of the resource. In other words, the modified program code includes the information necessary to provide the at least one display update action. The second version of the resource is generated based on the modified program code.

Referring back to FIG. 5, once the second version of the resource is generated and provided to a user on the user device, the rendering system may continue to collect interaction data, as indicated by loop 570. For example, in this second iteration, the rendering system will collect interaction data on the second version of the resource. The rendering system may input the interaction data into the first machine learning model configured to generate associations between user interaction types from the interaction data and display update actions, and the first machine learning model is configured to generate at least one display update action for the second version of the resource. Thereafter, a third version of the resource may be generated by the second machine learning model based on the at least one display update action for the second version of the resource. This third version of the resource is displayed on the user device. This process can repeat as long as the rendering system is monitoring the user interactions related to the resource.

In some non-limiting embodiments or aspects, the rendering system is configured to input the at least one display update action for the second version of the resource and the program code into the second machine learning model configured to modify the program code based on the at least one display update action for the second version of the resource. The rendering system may be further configured to receive modified program code to effect the at least one display update action for the second version of the resource, where the third version of the resource is generated based on the modified program code.

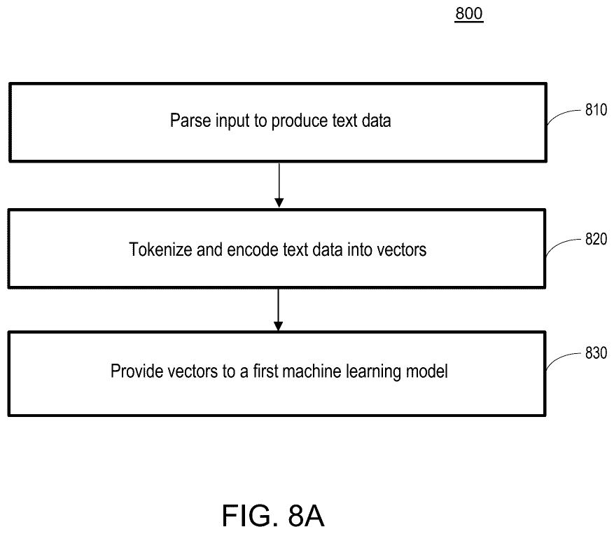

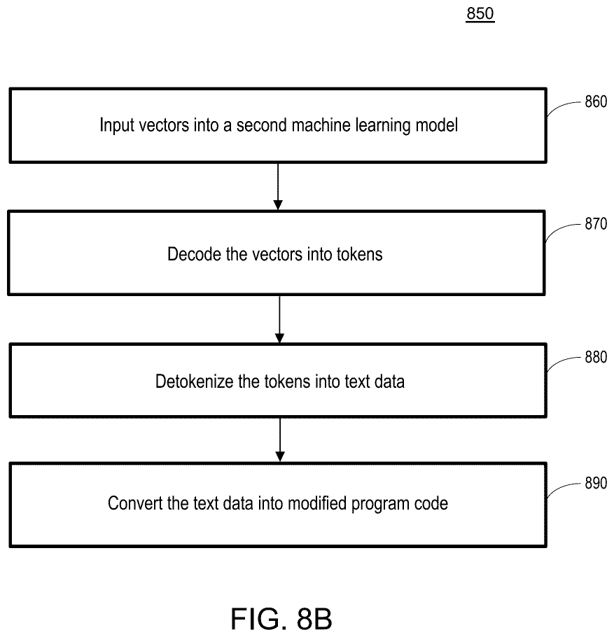

Referring now to FIG. 8A, a flow diagram of a method 800 for preparing inputs to a machine learning model is shown, according to some non-limiting embodiments or aspects. In some non-limiting embodiments or aspects, a step may be automatically performed in response to performance and/or completion of a prior step. Method 800 includes pre-processing steps 810-830 that may be used to prepare inputs to be in the correct format for processing in a machine learning model, such as an LLM, and according to the overall flow provided in FIG. 4.

At step 810, input is parsed to produce text data. As provided in the discussion of FIG. 4, dual inputs may be provided where input 1 is the current state of the resource that a user is interacting with and input 2 is the user customizations that are currently in place. Thus, if the resource is a webpage, input 1 is the current webpage and input 2 is the collected interaction data or feedback event for the current webpage.

In some non-limiting embodiments or aspects, at step 810, the collected interaction data is parsed into first text data. At step 820, the first text data is tokenized to produce a first plurality of tokens and the first plurality of tokens are encoded into a first plurality of vectors.

Similarly, at step 810, the content of the first version of the resource is parsed into second text data. At step 820, the second text data is tokenized to produce a second plurality of tokens and the second plurality of tokens are encoded into a second plurality of vectors.

While described as first and second text data, tokens, and vectors, it should be appreciated that the interaction data and content of the first resource may be interchangeable in order. The importance is getting the data into a compatible format as an input into the machine learning model. Thus, at step 830, the first plurality and/or second plurality of vectors are provided as input to the first machine learning model.

In some non-limiting embodiments or aspects, the first machine learning model is configured to combine the first plurality of vectors and the second plurality of vectors to produce a third plurality of vectors. This may occur, for example, as part of step 2 in FIG. 4, where the machine learning model may be able to draw correlations between the two inputs and provide potential enhancements in the resource state, so that the state is more aligned with the customizations. Thus, the third plurality of vectors correspond to input for the second machine learning model and used to generate the second version of the resource.

Referring now to FIG. 8B, a flow diagram of a method 850 for preparing inputs to a rendering model is shown, according to some non-limiting embodiments or aspects. In some non-limiting embodiments or aspects, a step may be automatically performed in response to performance and/or completion of a prior step. Method 850 includes processing steps 860-890 that may be used to prepare inputs to be in the correct format for processing in a rendering model and according to the overall flow provided in FIG. 4.

At step 860, the third plurality of vectors (output from the first machine learning model) is input to a second machine learning model. At step 870, the third plurality of vectors are decoded into a third plurality of tokens. At step 880, the third plurality of tokens are detokenized into third text data and, at step 890, the third text data are converted into modified program code for generating the second version of the resource.

It should be appreciated that step 3 of FIG. 4, where the fine-tuning is performed, one or more specialization layers are used that are able to understand the output of the first machine learning model and are able to convert it to a form that is renderable into a resource usable by the user. Thus, in step 4, the output is a customized resource that the user can display on the user device.

As each new round of collected interaction data is provided, a new set of vectors (e.g., fourth plurality of vectors) is provided to the first machine learning model and combined with the previous combined vectors (e.g., third plurality or vectors) to produce a new combined set of vectors (e.g., fifth plurality of vectors) that can be input into the second machine learning model to produce an updated customized resource (e.g. third version of the resource). This can continue as long as collected interaction data is provided and is shown clearly by the feedback loop in FIG. 3.

As described throughout the disclosure, proposed systems and methods can be used for solving a variety of different use-cases, including providing highly customized experiences to each and every individual which is extremely difficult and cost intensive today. For example:
Customization of resources to cater to specific autistic needs by emphasizing on visual structure as compared to text-intensive structure;
Customization of resources in native languages to improve readability which, in turn, improves accessibility;
Customization of resources to follow country-specific regulatory compliances like ADA (Americans with Disabilities Act); and
Customization of resources based on age to provide a more relevant experience to users of different age groups.

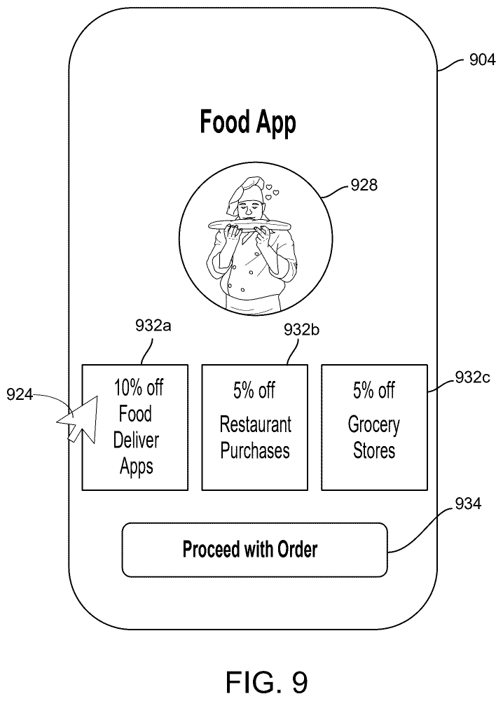

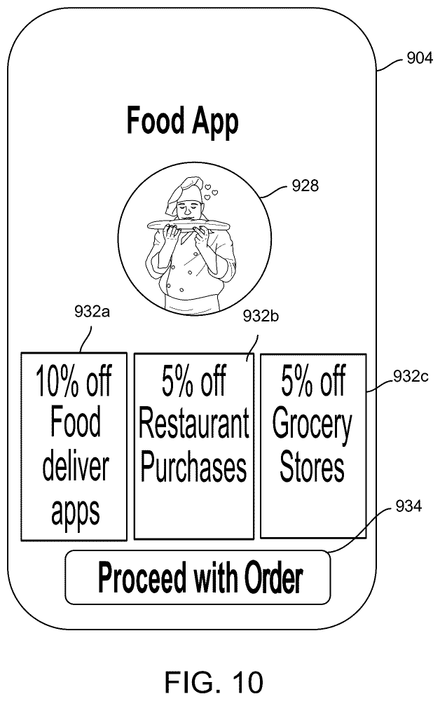

Referring now to FIGS. 9 and 10, an example user interface having a first and second font size (representing first and second versions), respectively, are shown, according to some non-limiting embodiments or aspects. As shown, the user interface 904 may include a food app with a suitably matched or represented “chef avatar” 928. The food app may include a number of user options, such as coupons, links, reward selection elements, etc. that represent different food-related options 932a, 932b, 932c.

In some non-limiting embodiments or aspects, the chef avatar 928 may correspond to a plurality of payment device rewards, and the user may select at least one payment device reward of a plurality of payment device rewards corresponding to the avatar 928. The plurality of payment device rewards corresponding to the avatar 928 may be displayed using reward selection elements 932a-932c, which are selectable elements. The user may select the desired reward selection element(s) 932a-932c, such as using a cursor 924 and/or by selecting the desired reward selection element(s) 932a-932c on the screen of the computing device 110 (e.g., by touching the desired reward selection element(s) 932a-932c).

In the non-limiting example shown in FIGS. 9 and 10, the plurality of payment device rewards corresponding to the chef-themed avatar 928 comprise rewards associated with food-related purchases. For example, a first reward selection element 932a may provide 10% off purchases made on food delivery applications; a second reward selection element 932b may provide 5% off restaurant purchases; and a third reward selection element 932c may provide 5% off grocery store purchases. It will be appreciated that any other payment device reward program may be designed for food-related purchases, and any type of payment device reward program may be designed for other categories of purchases. The user interface of the computing device may display a confirmation element 934, which may be a selectable element selected by the user to proceed with an order.

In accordance with the principles of the disclosure, if a user had the user interface 904 open and sensed interactions from the use of cursor 924 and/or if use of the user's fingers over the user interface 904 indicated that the font on user interface 904 was too small as depicted in FIG. 9, an updated version of the user interface 904, as shown in FIG. 10, may be returned to the user as the second version of the resource. It should be appreciated that this is just one simple example of how the methods and systems disclosed herein may be implemented.

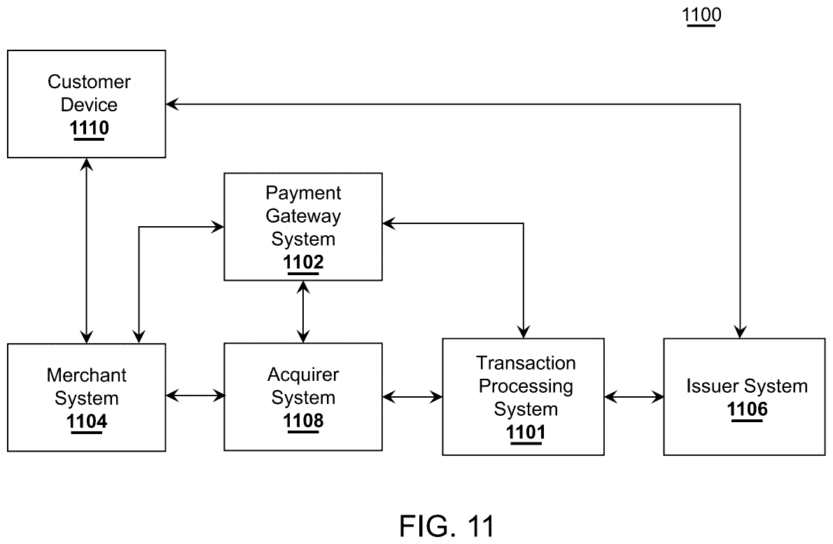

Referring now to FIG. 11, depicted is a diagram of an example payment processing network 1100, according to non-limiting embodiments or aspects. In some non-limiting embodiments or aspects, payment processing network 1100 may be used in conjunction with the systems, methods, and/or computer program products described herein, and/or the systems, methods, and/or computer program products described herein may be implemented in payment processing network 1100. As shown in FIG. 11, payment processing network 1100 may include transaction processing system 1101, payment gateway system 1102, merchant system 1104, issuer system 1106, acquirer system 1108, and/or consumer device 1110. In some non-limiting embodiments or aspects, each of machine learning model system 102, database 108, and/or user device 110 of FIG. 1 may be implemented by (e.g., part of) transaction processing system 1101. In some non-limiting embodiments or aspects, at least one of machine learning model system 102, database 108, and/or user device 110 of FIG. 1 may be implemented by (e.g., part of) another system, another device, another group of systems, or another group of devices, separate from or including transaction processing system 1101, such as merchant system 1104, issuer system 1106, acquirer system 1108, consumer device 1110, and/or the like. For example, user device 110 may be implemented by (e.g., part of) at least one of payment gateway system 1102, merchant system 1104, issuer system 1106, acquirer system 1108, and/or consumer device 1110. Additionally or alternatively, for example, database 108 may be implemented by (e.g., part of) at least one of payment gateway system 1102, merchant system 1104, issuer system 1106, acquirer system 1108, and/or consumer device 1110.

Transaction processing system 1101 may include one or more devices capable of receiving information from and/or communicating information to payment gateway system 1102, merchant system 1104, issuer system 1106, acquirer system 1108, consumer device 1110, and/or the like (e.g., directly, indirectly, via a public and/or private communication network connection, and/or the like). For example, as shown in FIG. 11, transaction processing system 1101 may be in communication with one or more issuer systems (e.g., issuer system 1106), one or more acquirer systems (e.g., acquirer system 1108), and/or one or more payment gateway systems (e.g., payment gateway system 1102). Although only a single issuer system 1106, single acquirer system 1108, and single payment gateway system 1102 are shown, it will be appreciated that transaction processing system 1101 may be in communication with a plurality of issuer systems, a plurality of acquirer systems, and/or a plurality of payment gateways. In some non-limiting embodiments or aspects, transaction processing system 1101 may include a computing device, such as a server (e.g., a transaction processing server), a group of servers, and/or other like devices. In some non-limiting embodiments or aspects, transaction processing system 1101 may be in communication with a data storage device, which may be local or remote to transaction processing system 1101. In some non-limiting embodiments or aspects, transaction processing system 1101 may be capable of receiving information from, storing information in, communicating information to, or searching information stored in a data storage device. In some non-limiting embodiments or aspects, transaction processing system 1101 may be associated with a transaction service provider, as described herein. In some non-limiting embodiments or aspects, transaction processing system 1101 may also operate as an issuer system, such that both transaction processing system 1101 and issuer system 1106 are a single system and/or controlled by a single entity.

Payment gateway system 1102 may include one or more devices capable of receiving information from and/or communicating information to transaction processing system 1101, merchant system 1104, issuer system 1106, acquirer system 1108, consumer device 1110, and/or the like (e.g., directly, indirectly, via a public and/or private communication network connection, and/or the like). For example, as shown in FIG. 11, payment gateway system 1102 may be in communication with one or more merchant systems (e.g., merchant system 1104), one or more acquirer systems (e.g., acquirer system 1108), and/or one or more transaction processing systems (e.g., transaction processing system 1101). Although only a single merchant system 1104, single acquirer system 1108, and single transaction processing system 1101 are shown, it will be appreciated that payment gateway system 1102 may be in communication with a plurality of merchant systems, a plurality of acquirer systems, and/or a plurality of transaction processing systems. In some non-limiting embodiments or aspects, payment gateway system 1102 may include a computing device, such as a server, a group of servers, and/or other like devices. In some non-limiting embodiments or aspects, payment gateway system 1102 may be associated with a payment gateway, as described herein.

Merchant system 1104 may include one or more devices capable of receiving information from and/or communicating information to transaction processing system 1101, payment gateway system 1102, issuer system 1106, acquirer system 1108, consumer device 1110, and/or the like (e.g., directly, indirectly, via a public and/or private communication network connection, and/or the like). For example, as shown in FIG. 11, merchant system 1104 may be in communication with one or more payment gateway systems (e.g., payment gateway system 1102), one or more acquirer systems (e.g., acquirer system 1108), and/or one or more consumer devices (e.g., consumer device 1110). Although only a single payment gateway system 1102, single acquirer system 1108, and single consumer device 1110 are shown, it will be appreciated that merchant system 1104 may be in communication with a plurality of payment gateway systems, a plurality of acquirer systems, and/or a plurality of consumer devices. In some non-limiting embodiments or aspects, merchant system 1104 may include a computing device, such as a server, a group of servers, a client device, a group of client devices, a POS device, a POS system, computers, computer systems, peripheral devices, and/or other like devices. In some non-limiting embodiments or aspects, merchant system 1104 may be associated with a merchant, as described herein. In some non-limiting embodiments or aspects, merchant system 1104 may include a device capable of receiving information from and/or communicating information to consumer device 1110 via a short range communication connection (e.g., an NFC communication connection, an RFID communication connection, a Bluetooth® communication connection, a Zigbee® communication connection, and/or the like) with consumer device 1110 and/or the like. In some non-limiting embodiments or aspects, merchant system 1104 may include one or more client devices. For example, merchant system 1104 may include a client device that allows a merchant to communicate information to transaction processing system 1101 (e.g., via at least one of acquirer system 1108 and/or payment gateway system 1102). In some non-limiting embodiments or aspects, merchant system 1104 (e.g., a client device thereof, a POS device thereof, and/or the like) may also operate as a payment gateway system such that both merchant system 1104 and payment gateway system 1102 are a single system and/or controlled by a single entity.

Issuer system 1106 may include one or more devices capable of receiving information and/or communicating information to transaction processing system 1101, payment gateway system 1102, merchant system 1104, acquirer system 1108, consumer device 1110, and/or the like (e.g., directly, indirectly, via a public and/or private communication network connection, and/or the like). For example, as shown in FIG. 11, issuer system 1106 may be in communication with one or more transaction processing systems (e.g., transaction processing system 1101) and/or one or more consumer devices (e.g., consumer device 1110). Although only a single transaction processing system 1101 and a single consumer device 1110 are shown, it will be appreciated that issuer system 1106 may be in communication with a plurality of transaction processing systems and/or a plurality of consumer devices 1110. In some non-limiting embodiments or aspects, issuer system 1106 may include a computing device, such as a server, a group of servers, and/or other like devices. In some non-limiting embodiments or aspects, issuer system 1106 may be associated with an issuer institution, as described herein. For example, issuer system 1106 may be associated with an issuer institution that issued a credit account, debit account, credit card, debit card, a payment device, and/or the like to a user associated with consumer device 1110.

Acquirer system 1108 may include one or more devices capable of receiving information from and/or communicating information to transaction processing system 1101, payment gateway system 1102, merchant system 1104, issuer system 1106, consumer device 1110, and/or the like (e.g., directly, indirectly, via a public and/or private communication network connection, and/or the like). For example, as shown in FIG. 11, acquirer system 1108 may be in communication with one or more transaction processing systems (e.g., transaction processing system 1101), one or more payment gateway systems (e.g., payment gateway system 1102), and/or one or more merchant systems (e.g., merchant system 1104). Although only a single transaction processing system 1101, a single payment gateway system 1102, and a single merchant system 1104 are shown, it will be appreciated that acquirer system 1108 may be in communication with a plurality of transaction processing systems, a plurality of payment gateway systems, and/or a plurality of merchant systems. In some non-limiting embodiments or aspects, acquirer system 1108 may include a computing device, such as a server, a group of servers, and/or other like devices. In some non-limiting embodiments or aspects, acquirer system 1108 may be associated with an acquirer institution, as described herein.

Consumer device 1110 may include one or more devices capable of receiving information from and/or communicating information to transaction processing system 1101, payment gateway system 1102, merchant system 1104, issuer system 1106, acquirer system 1108, and/or the like (e.g., directly, indirectly, via a public and/or private communication network connection, and/or the like). For example, as shown in FIG. 11, consumer device 1110 may be in communication with one or more merchant systems (e.g., merchant system 1104) and/or one or more issuer systems (e.g., issuer system 1106). Although only a single merchant system 1104 and a single issuer system 1106 are shown, it will be appreciated that consumer device 1110 may be in communication with a plurality of merchant systems and/or a plurality of issuer systems. In some non-limiting embodiments or aspects, consumer device 1110 may be associated with a user to whom a credit account, a debit account, a credit card, a debit card, a payment device, and/or the like has been issued. In some non-limiting embodiments or aspects, consumer device 1110 may include a computing device, such as a computer, a portable computer, a laptop computer, a tablet computer, a mobile device, a cellular phone, a smartphone, a wearable device (e.g., watches, glasses, lenses, clothing, and/or the like), a PDA, a client device, and/or other like devices. In some non-limiting embodiments or aspects, consumer device 1110 may include a payment device, as described herein. In some non-limiting embodiments or aspects, consumer device 1110 may include a device capable of receiving information from and/or communicating information to other user devices 1110 (e.g., directly, indirectly, via a public and/or private communication network connection, a short range communication connection, and/or the like). In some non-limiting embodiments or aspects, consumer device 1110 may include a device capable of receiving information from and/or communicating information to merchant system 1104 via a short range communication connection (e.g., an NFC communication connection, an RFID communication connection, a Bluetooth® communication connection, a Zigbee® communication connection, and/or the like) with merchant system 1104 and/or the like. In some non-limiting embodiments or aspects, consumer device 1110 may include a client device.

In some non-limiting embodiments or aspects, transaction processing system 1101 may communicate with merchant system 1104 directly (e.g., via a public and/or private communication network connection and/or the like). Additionally or alternatively, transaction processing system 1101 may communicate with merchant system 1104 through payment gateway system 1102 and/or acquirer system 1108. In some non-limiting embodiments or aspects, an acquirer system 1108 associated with merchant system 1104 may operate as payment gateway system 1102 to facilitate the communication of transaction messages (e.g., authorization requests) from merchant system 1104 to transaction processing system 1101. In some non-limiting embodiments or aspects, merchant system 1104 may communicate with payment gateway 1102 directly (e.g., via a public and/or private communication network connection and/or the like). For example, a merchant system 1104 that includes a physical POS device may communicate with payment gateway 1102 through a public or private network to conduct card-present transactions. As another example, a merchant system 1104 that includes a server (e.g., a web server) may communicate with payment gateway 1102 through a public or private network, such as the Internet, to conduct card-not-present transactions.

For the purpose of illustration, processing a transaction (e.g., a payment transaction) may include generating a transaction message (e.g., authorization request and/or the like) based on an account identifier of a customer (e.g., accountholder associated with consumer device 1110 and/or the like) and/or transaction data associated with the transaction. For example, merchant system 1104 (e.g., a client device of merchant system 1104, a POS device of merchant system 1104, and/or the like) may initiate the transaction, e.g., by generating an authorization request (e.g., in response to receiving the account identifier from a payment device and/or a portable financial device of the customer and/or the like). Merchant system 1104 may communicate the authorization request to payment gateway 1102 and/or acquirer system 1108. In some non-limiting embodiments or aspects, payment gateway 1102 may communicate the authorization request to acquirer system 1108 and/or transaction processing system 1101. Additionally or alternatively, acquirer system 1108 (and/or payment gateway 1102) may communicate the authorization request to transaction processing system 1101. After receiving the authorization request from merchant system 1104 that identifies the account identifier of the customer (e.g., the accountholder associated with consumer device 1110 and/or the account identifier), transaction processing system 1101 may communicate the authorization request to issuer system 1106 (e.g., the issuer system that issued the payment device and/or account identifier). Issuer system 1106 may determine an authorization decision (e.g., approve, deny, and/or the like) based on the authorization request, and/or issuer system 1106 may generate an authorization response based on the authorization decision and/or the authorization request. Issuer system 1106 may communicate the authorization response to transaction processing system 1101. Transaction processing system 1101 may communicate the authorization response to acquirer system 1108 and/or payment gateway 1102. In some non-limiting embodiments or aspects, acquirer system 1108 may communicate the authorization response to payment gateway 1102 and/or merchant system 1104. Additionally or alternatively, payment gateway 1102 (and/or acquirer system 1108) may communicate the authorization response to merchant system 1104.

In some non-limiting embodiments or aspects, transaction processing system 1101 and/or issuer system 1106 may include at least one machine learning model (e.g., at least one of a fraud detection model, a risk detection model, a transaction authorization model, a credit approval model, a product recommendation model, a classifier model, an anomaly detection model, an authentication model, any combination thereof, and/or the like). For example, the machine learning model(s) may be trained based on generated data records, as described herein. Transaction processing system 1101 and/or issuer system 1106 may perform at least one task (e.g., generate at least one prediction) based on the authorization request and the machine learning model(s). For example, performing the task(s) may include generating at least one prediction associated with fraud detection, risk detection, transaction authorization, credit approval, product recommendation, classification, anomaly detection, authentication, any combination thereof, and/or the like. In some non-limiting embodiments or aspects, transaction processing system 1101 may communicate at least one message based on performing the task (e.g., generating the prediction) to issuer system 1106 (e.g., along with the authorization request). In some non-limiting embodiments or aspects, issuer system 1106 may determine the authorization decision (e.g., approve, deny, and/or the like) based on the authorization request and the performance of the task (e.g., generation of the prediction).

For the purpose of illustration, clearing and/or settlement of a transaction may include generating a message (e.g., clearing message and/or the like) based on an account identifier of a customer (e.g., associated with consumer device 1110 and/or the like) and/or transaction data associated with the transaction. For example, merchant system 1104 may generate at least one clearing message (e.g., a plurality of clearing messages, a batch of clearing messages, and/or the like). Merchant system 1104 may communicate the clearing message(s) to acquirer system 1108 (and/or payment gateway 1102, which may communicate the clearing message(s) to acquirer system 1108). Acquirer system 1108 may communicate the clearing message(s) to transaction processing system 1101. Transaction processing system 1101 may communicate the clearing message(s) to issuer system 1106. Issuer system 1106 may generate at least one settlement message based on the clearing message(s). In some non-limiting embodiments or aspects, issuer system 1106 may communicate the settlement message(s) and/or funds to transaction processing system 1101 (and/or a settlement bank system associated with transaction processing system 1101), and transaction processing system 1101 (and/or the settlement bank system) may communicate the settlement message(s) and/or funds to acquirer system 1108. Additionally or alternatively, issuer system 1106 may communicate the settlement message(s) and/or funds to acquirer system 1108. In some non-limiting embodiments or aspects, acquirer system 1108 may communicate settlement message(s) and/or funds to merchant system 1104 (and/or an account associated with merchant system 1104).

The systems and/or devices of FIG. 11 may communicate via one or more wired and/or wireless communication networks. For example, the communication network(s) may include a cellular network (e.g., a long-term evolution (LTE®) network, a third generation (3G) network, a fourth generation (4G) network, a fifth generation (5G) network, a code division multiple access (CDMA) network, and/or the like), a public land mobile network (PLMN), a local area network (LAN), a wide area network (WAN), a metropolitan area network (MAN), a telephone network (e.g., the public switched telephone network (PSTN)), a private network (e.g., a private network associated with a transaction service provider), an ad hoc network, an intranet, the Internet, a fiber optic-based network, a cloud computing network, and/or the like, and/or a combination of these or other types of networks.

The number and arrangement of systems, devices, and/or networks shown in FIG. 11 are provided as an example. There may be additional systems, devices, and/or networks; fewer systems, devices, and/or networks; different systems, devices, and/or networks; and/or differently arranged systems, devices, and/or networks than those shown in FIG. 11. Furthermore, two or more systems or devices shown in FIG. 11 may be implemented within a single system or device, or a single system or device shown in FIG. 11 may be implemented as multiple, distributed systems or devices. Additionally or alternatively, a set of systems (e.g., one or more systems) or a set of devices (e.g., one or more devices) of payment processing network 1100 may perform one or more functions described as being performed by another set of systems or another set of devices of payment processing network 1100.

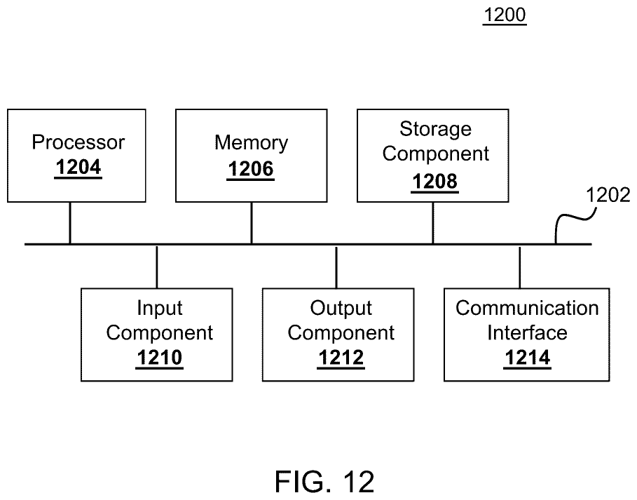

Referring now to FIG. 12, shown is a diagram of example components of a device 1200, according to non-limiting embodiments or aspects. Device 1200 may correspond to machine learning model system 102, first machine learning model 104, second machine learning model 106, database 108, user device 110, and/or rendering system 112 of FIG. 1 and/or user device 210, rendering system 220, and/or transformer model 230 of FIG. 2 and/or user device 310, rendering system 320, and/or transformer model 330 of FIG. 3 and/or system 400, first machine learning model 420, and/or second machine learning model 430 of FIG. 4 and/or transaction service provider system 1102, issuer system 1104, issuer system 1106, merchant system 1108, acquirer system 1110, and/or communication network 1112 of FIG. 11, as an example. In some non-limiting embodiments or aspects, such systems or devices may include at least one device 1200 and/or at least one component of device 1200. The number and arrangement of components shown are provided as an example. In some non-limiting embodiments or aspects, device 1200 may include additional components, fewer components, different components, or differently arranged components than those shown. Additionally, or alternatively, a set of components (e.g., one or more components) of device 1200 may perform one or more functions described as being performed by another set of components of device 1200.

As shown in FIG. 12, device 1200 may include a bus 1202, a processor 1204, memory 1206, a storage component 1208, an input component 1210, an output component 1212, and a communication interface 1214. Bus 1202 may include a component that permits communication among the components of device 1200. In some non-limiting embodiments, processor 1204 may be implemented in hardware, firmware, or a combination of hardware and software. For example, processor 1204 may include a processor (e.g., a central processing unit (CPU), a graphics processing unit (GPU), an accelerated processing unit (APU), etc.), a microprocessor, a digital signal processor (DSP), and/or any processing component (e.g., a field-programmable gate array (FPGA), an application-specific integrated circuit (ASIC), etc.) that can be programmed to perform a function. Memory 1206 may include random access memory (RAM), read only memory (ROM), and/or another type of dynamic or static storage device (e.g., flash memory, magnetic memory, optical memory, etc.) that stores information and/or instructions for use by processor 1204.

With continued reference to FIG. 12, storage component 1208 may store information and/or software related to the operation and use of device 1200. For example, storage component 1208 may include a hard disk (e.g., a magnetic disk, an optical disk, a magneto-optic disk, a solid-state disk, etc.) and/or another type of computer-readable medium. Input component 1210 may include a component that permits device 1200 to receive information, such as via user input (e.g., a touch screen display, a keyboard, a keypad, a mouse, a button, a switch, a microphone, etc.). Additionally, or alternatively, input component 1210 may include a sensor for sensing information (e.g., a global positioning system (GPS) component, an accelerometer, a gyroscope, an actuator, etc.). Output component 1212 may include a component that provides output information from device 1200 (e.g., a display, a speaker, one or more light-emitting diodes (LEDs), etc.). Communication interface 1214 may include a transceiver-like component (e.g., a transceiver, a separate receiver and transmitter, etc.) that enables device 1200 to communicate with other devices, such as via a wired connection, a wireless connection, or a combination of wired and wireless connections. Communication interface 1214 may permit device 1200 to receive information from another device and/or provide information to another device. For example, communication interface 1214 may include an Ethernet interface, an optical interface, a coaxial interface, an infrared interface, a radio frequency (RF) interface, a universal serial bus (USB) interface, a Wi-Fi® interface, a cellular network interface, and/or the like.

Device 1200 may perform one or more processes described herein. Device 1200 may perform these processes based on processor 1204 executing software instructions stored by a computer-readable medium, such as memory 1206 and/or storage component 1208. A computer-readable medium may include any non-transitory memory device. A memory device includes memory space located inside of a single physical storage device or memory space spread across multiple physical storage devices. Software instructions may be read into memory 1206 and/or storage component 1208 from another computer-readable medium or from another device via communication interface 1214. When executed, software instructions stored in memory 1206 and/or storage component 1208 may cause processor 1204 to perform one or more processes described herein. Additionally, or alternatively, hardwired circuitry may be used in place of or in combination with software instructions to perform one or more processes described herein. Thus, embodiments described herein are not limited to any specific combination of hardware circuitry and software. The term “configured to,” as used herein, may refer to an arrangement of software, device(s), and/or hardware for performing and/or enabling one or more functions (e.g., actions, processes, steps of a process, and/or the like). For example, “a processor configured to” may refer to a processor that executes software instructions (e.g., program code) that cause the processor to perform one or more functions.

Although embodiments have been described in detail for the purpose of illustration, it is to be understood that such detail is solely for that purpose and that the disclosure is not limited to the disclosed embodiments or aspects, but, on the contrary, is intended to cover modifications and equivalent arrangements that are within the spirit and scope of the appended claims. For example, it is to be understood that the present disclosure contemplates that, to the extent possible, one or more features of any embodiment or aspect can be combined with one or more features of any other embodiment or aspect.

What is claimed is:

1. A system comprising at least one processor configured to:
receive a user request from a user device to access a resource;
in response to receiving the user request, retrieve program code configured to cause display of the resource;
generate a first version of the resource based on the program code, the first version of the resource displayed on the user device;
collect interaction data based on sensed interactions of a user of the user device with the displayed first version of the resource;
input the interaction data into a first machine learning model configured to generate associations between user interaction types from the interaction data and display update actions, the first machine learning model configured to generate at least one display update action for the first version of the resource; and
generate, by a second machine learning model, a second version of the resource based on the at least one display update action for the first version of the resource, the second version of the resource displayed on the user device.

2. The system of claim 1, wherein the at least one processor is further configured to:
input the at least one display update action for the first version of the resource and the program code into the second machine learning model configured to modify the program code based on the at least one display update action for the first version of the resource; and
receive modified program code to effect the at least one display update action for the first version of the resource,
wherein the second version of the resource is generated based on the modified program code.

3. The system of claim 1, wherein, when receiving the user request to access a resource, the at least one processor is configured to:
receive a URL request in a browser to render a webpage; and
receive at least one parameter related to how the webpage is rendered.

4. The system of claim 1, wherein when retrieving program code configured to cause display of the resource, the at least one processor is configured to:
connect to a server hosting the resource;
request the program code configured to cause display of the resource, including at least one parameter related to how the resource is rendered; and
receive a response comprising the program code from the server hosting the resource,
wherein the first version of the resource is generated based on the response.

5. The system of claim 1, wherein when collecting interaction data, the at least one processor is configured to:
monitor the sensed interactions of the user of the user device for a feedback event, wherein the feedback event is explicit or implicit.

6. The system of claim 5, wherein the monitoring for a feedback event comprises continuously and/or continually monitoring for any feedback events based on the sensed interactions of the user of the user device in real-time.

7. The system of claim 5, wherein the feedback event is based on a user interaction pattern.

8. The system of claim 5, wherein the feedback event is an explicit request from the user.

9. The system of claim 5, wherein the feedback event is an implicit request from the user.

10. The system of claim 1, wherein when inputting the interaction data into the first machine learning model, the at least one processor is configured to:
parse the collected interaction data into first text data;
tokenize the first text data to produce a first plurality of tokens; and
encode the first plurality of tokens into a first plurality of vectors, the first plurality of vectors being input to the first machine learning model.

11. The system of claim 10, the at least one processor configured to:
input content from the first version of the resource into the first machine learning model by:
parsing the content of the first version of the resource into second text data;
tokenizing the second text data to produce a second plurality of tokens; and
encoding the second plurality of tokens into a second plurality of vectors, the second plurality of vectors being input to the first machine learning model.

12. The system of claim 11, wherein the first machine learning model is configured to combine the first plurality of vectors and the second plurality of vectors to produce a third plurality of vectors, the third plurality of vectors corresponding to input used to generate the second version of the resource.

13. The system of claim 12, the at least one processor configured to:
input the third plurality of vectors into the second machine learning model, the second machine learning model configured to:
decode the third plurality of vectors into a third plurality of tokens;
detokenize the third plurality of tokens into third text data; and
convert the third text data into modified program code for generating the second version of the resource.

14. The system of claim 1, wherein the resource comprises at least one of a webpage, a mobile app, and/or a gaming environment.

15. The system of claim 1, wherein generating the first version and/or the second version of the resource comprises generating and rendering the first version and/or the second version of the resource.

16. The system of claim 1, wherein the at least one processor is further configured to:
input the interaction data into a first machine learning model configured to generate associations between user interaction types from the interaction data and display update actions, the first machine learning model configured to generate at least one display update action for the second version of the resource; and
generate, by a second machine learning model, a third version of the resource based on the at least one display update action for the second version of the resource, the third version of the resource displayed on the user device.

17. The system of claim 16, the at least one processor further configured to:
input the at least one display update action for the second version of the resource and the program code into the second machine learning model configured to modify the program code based on the at least one display update action for the second version of the resource; and
receive modified program code to effect the at least one display update action for the second version of the resource,
wherein the third version of the resource is generated based on the modified program code.

18. The system of claim 16, wherein when inputting the interaction data into the first machine learning model, the at least one processor is configured to:
parse the collected interaction data into fourth text data;
tokenize the fourth text data to produce a fourth plurality of tokens; and
encode the fourth plurality of tokens into a fourth plurality of vectors, the fourth plurality of vectors being input to the first machine learning model.

19. The system of claim 18, the at least one processor configured to:
input the content from the second version of the resource into the first machine learning model by:
parsing the content of the second version of the resource back into third text data;
tokenizing the third text data to produce the third plurality of tokens; and
encoding the third plurality of tokens into the third plurality of vectors, the third plurality of vectors being input to the first machine learning model.

20. The system of claim 19, wherein the first machine learning model is configured to combine the fourth plurality of vectors and the third plurality of vectors to produce a fifth plurality of vectors, the fifth plurality of vectors corresponding to input used to generate the third version of the resource.
